(19) United States
(12) Patent Application Publication
(10) Pub. No.: US 2026/0323521 A1
(43) Pub. Date: Oct. 15, 2026

(54) TECHNIQUES FOR SWITCHING BETWEEN DOWNLINK CONTROL CHANNEL MONITORING USING WAKE-UP SIGNALS AND DISCONTINUOUS RECEPTION

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Igor GUTMAN, Hod HaSharon (IL); Jelena DAMNJANOVIC, Del Mar, CA (US)

(21) Appl. No.: 19/464,455

(22) Filed: Jan. 29, 2026

Related U.S. Application Data
(60) Provisional application No. 63/754,396, filed on Feb. 5, 2025.

(51) Int. Cl. H04W 52/02; H04W 72/23; H04W 76/28

(52) U.S. Cl. CPC H04W 52/0235; H04W 72/23; H04W 76/28

(57) ABSTRACT

Methods, systems, and devices for wireless communications are described. In some cases, a user equipment (UE) may receive a first control message indicating a configuration of a set of parameters applicable to a first low-power wake-up signal (LP-WUS) monitoring technique and a second LP-WUS monitoring technique, different from the first LP-WUS monitoring technique. The UE may monitor, based on one or more discontinuous reception (DRX) cycles, for one or more LP-WUSs in accordance with the set of parameters and the first LP-WUS monitoring technique. The UE may receive a second control message indicating a switch between the first LP-WUS monitoring technique and the second LP-WUS monitoring technique, such that the UE may monitor, based on the one or more DRX cycles, for the one or more LP-WUS in accordance with the set of parameters and the second LP-WUS signal monitoring technique.

### CROSS REFERENCE

The present Application for Patent claims the benefit of U.S. Provisional Patent Application No. 63/754,396 by RYU et al., entitled “TECHNIQUES FOR SWITCHING BETWEEN DOWNLINK CONTROL CHANNEL MONITORING USING WAKE-UP SIGNALS AND DISCONTINUOUS RECEPTION,” filed Feb. 5, 2025, assigned to the assignee hereof, and expressly incorporated by reference herein.

### INTRODUCTION

The following relates to wireless communications, including techniques for downlink control channel monitoring during a connected mode discontinuous reception (C-DRX) cycle.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications at a UE is described. The method may include receiving a first control message that indicates a configuration of a set of one or more parameters applicable to both a first low-power wake-up signal (LP-WUS) monitoring technique and a second LP-WUS monitoring technique that is different from the first LP-WUS monitoring technique, monitoring, based on one or more DRX cycles, for one or more LP-WUSs in accordance with the set of one or more parameters and the first LP-WUS monitoring technique, receiving a second control message indicative of a switch between the first LP-WUS monitoring technique and the second LP-WUS monitoring technique, and monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

An apparatus for wireless communications at a UE is described. The apparatus may include one or more memories, and one or more processors coupled with the one or more memories. The one or more processors may be configured to cause the UE to receive a first control message that indicates a configuration of a set of one or more parameters applicable to both a first LP-WUS monitoring technique and a second LP-WUS monitoring technique that is different from the first LP-WUS monitoring technique, monitor, based on one or more DRX cycles, for one or more LP-WUSs in accordance with the set of one or more parameters and the first LP-WUS monitoring technique, receive a second control message indicative of a switch between the first LP-WUS monitoring technique and the second LP-WUS monitoring technique, and monitor, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

Another apparatus for wireless communications is described. The apparatus may include means for receiving a first control message that indicates a configuration of a set of one or more parameters applicable to both a first LP-WUS monitoring technique and a second LP-WUS monitoring technique that is different from the first LP-WUS monitoring technique, means for monitoring, based on one or more DRX cycles, for one or more LP-WUSs in accordance with the set of one or more parameters and the first LP-WUS monitoring technique, means for receiving a second control message indicative of a switch between the first LP-WUS monitoring technique and the second LP-WUS monitoring technique, and means for monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

A non-transitory computer-readable medium storing code for wireless communications is described. The code may include instructions executable by one or more processors to receive a first control message that indicates a configuration of a set of one or more parameters applicable to both a first LP-WUS monitoring technique and a second LP-WUS monitoring technique that is different from the first LP-WUS monitoring technique, monitor, based on one or more DRX cycles, for one or more LP-WUSs in accordance with the set of one or more parameters and the first LP-WUS monitoring technique, receive a second control message indicative of a switch between the first LP-WUS monitoring technique and the second LP-WUS monitoring technique, and monitor, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

In some examples of the method, apparatus, and non-transitory computer-readable medium described herein, each LP-WUS of the one or more LP-WUSs may be associated with an LP-WUS monitoring occasion (MO) of one or more LP-WUS MOs and the set of one or more parameters include a periodicity associated with the one or more LP-WUS MOs, a slot offset associated with the one or more LP-WUS MOs, a duration associated with each of the one or more LP-WUS MOs, or any combination thereof.

In some examples of the method, apparatus, and non-transitory computer-readable medium described herein, the first control message includes one or more indications of the first LP-WUS monitoring technique and the one or more LP-WUSs may be monitored in accordance with the first LP-WUS monitoring technique based on the one or more indications.

In some examples of the method, apparatus, and non-transitory computer-readable medium described herein, the one or more indications includes a variable, a first value of the variable indicates the first LP-WUS monitoring technique, and a second value of the variable indicates the second LP-WUS monitoring technique.

In some examples of the method, apparatus, and non-transitory computer-readable medium described herein, the second control message indicates the switch between the first LP-WUS monitoring technique and the second LP-WUS monitoring technique via an indication that the first LP-WUS monitoring technique, the second LP-WUS monitoring technique, or both, may be activated.

In some examples of the method, apparatus, and non-transitory computer-readable medium described herein, the second control message includes a single-bit field indicative of the switch, a first value of the single-bit field indicates the first LP-WUS monitoring technique may be activated, and a second value of the single-bit field indicates the second LP-WUS monitoring technique may be activated.

In some examples of the method, apparatus, and non-transitory computer-readable medium described herein, the second control message includes a multi-bit field indicative of the switch, a first value of the multi-bit field indicates the first LP-WUS monitoring technique may be activated, a second value of the multi-bit field indicates the second LP-WUS monitoring technique may be activated, a third value of the multi-bit field indicates both the first LP-WUS monitoring technique and the second LP-WUS monitoring technique may be activated, and a fourth value of the multi-bit field indicates both the first LP-WUS monitoring technique and the second LP-WUS monitoring technique may be deactivated.

In some examples of the method, apparatus, and non-transitory computer-readable medium described herein, the second control message indicates the switch between the first LP-WUS monitoring technique and the second LP-WUS monitoring technique via an indication of a switch from the first LP-WUS monitoring technique to the second LP-WUS monitoring technique.

In some examples of the method, apparatus, and non-transitory computer-readable medium described herein, the second control message includes an indication of a downlink control channel monitoring duration.

In some examples of the method, apparatus, and non-transitory computer-readable medium described herein, the second control message may be associated with a logical channel identifier (LCID) that indicates the second control message may be associated with LP-WUS-based downlink control channel monitoring.

In some examples of the method, apparatus, and non-transitory computer-readable medium described herein, the second control message includes a medium access control (MAC)-control element (CE) message.

In some examples of the method, apparatus, and non-transitory computer-readable medium described herein, the second control message includes a MAC-CE message associated with an LCID that indicates the MAC-CE message is associated with LP-WUS-based downlink control channel monitoring.

In some examples of the method, apparatus, and non-transitory computer-readable medium described herein, the second control message includes an indication of a validity duration associated with the switch between the first LP-WUS monitoring technique and the second LP-WUS monitoring technique.

In some examples of the method, apparatus, and non-transitory computer-readable medium described herein, the first control message includes a first radio resource control (RRC) information element (IE) indicative of the set of one or more parameters.

In some examples of the method, apparatus, and non-transitory computer-readable medium described herein, the set of one or more parameters may be independent of a second set of one or more parameters associated with the one or more DRX cycles.

In some examples of the method, apparatus, and non-transitory computer-readable medium described herein, the first LP-WUS monitoring technique may be associated with one or more of reception of one or more downlink messages during one or more active durations of the one or more DRX cycles based on reception of the one or more LP-WUSs or reception of the one or more downlink messages during one or more inactive durations of the one or more DRX cycles based on reception of the one or more LP-WUSs.

In some examples of the method, apparatus, and non-transitory computer-readable medium described herein, the second LP-WUS monitoring technique may be associated with one or more of reception of one or more downlink messages during one or more active durations of the one or more DRX cycles based on reception of the one or more LP-WUSs or reception of the one or more downlink messages during one or more inactive durations of the one or more DRX cycles based on reception of the one or more LP-WUSs.

A method for wireless communications at a network entity is described. The method may include outputting a first control message that indicates a configuration of a set of one or more parameters applicable to both a first LP-WUS monitoring technique and a second LP-WUS monitoring technique that is different from the first LP-WUS monitoring technique, outputting, based on one or more DRX cycles, one or more LP-WUSs in accordance with the set of one or more parameters and the first LP-WUS monitoring technique, outputting a second control message indicative of a switch between the first LP-WUS monitoring technique and the second LP-WUS monitoring technique, and outputting, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

An apparatus for wireless communications at a network entity is described. The apparatus may include one or more memories, and one or more processors coupled with the one or more memories. The one or more processors may be configured to cause the network entity to output a first control message that indicates a configuration of a set of one or more parameters applicable to both a first LP-WUS monitoring technique and a second LP-WUS monitoring technique that is different from the first LP-WUS monitoring technique, output, based on one or more DRX cycles, one or more LP-WUSs in accordance with the set of one or more parameters and the first LP-WUS monitoring technique, output a second control message indicative of a switch between the first LP-WUS monitoring technique and the second LP-WUS monitoring technique, and output, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

Another apparatus for wireless communications is described. The network entity may include means for outputting a first control message that indicates a configuration of a set of one or more parameters applicable to both a first LP-WUS monitoring technique and a second LP-WUS monitoring technique that is different from the first LP-WUS monitoring technique, means for outputting, based on one or more DRX cycles, one or more LP-WUSs in accordance with the set of one or more parameters and the first LP-WUS monitoring technique, means for outputting a second control message indicative of a switch between the first LP-WUS monitoring technique and the second LP-WUS monitoring technique, and means for outputting, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

A non-transitory computer-readable medium storing code for wireless communications is described. The code may include instructions executable by one or more processors to output a first control message that indicates a configuration of a set of one or more parameters applicable to both a first LP-WUS monitoring technique and a second LP-WUS monitoring technique that is different from the first LP-WUS monitoring technique, output, based on one or more DRX cycles, one or more LP-WUSs in accordance with the set of one or more parameters and the first LP-WUS monitoring technique, output a second control message indicative of a switch between the first LP-WUS monitoring technique and the second LP-WUS monitoring technique, and output, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

In some examples of the method, apparatus, and non-transitory computer-readable medium described herein, each LP-WUS of the one or more LP-WUSs may be associated with an LP-WUS MO of one or more LP-WUS MOs and the set of one or more parameters include a periodicity associated with the one or more LP-WUS MOs, a slot offset associated with the one or more LP-WUS MOs, a duration associated with each of the one or more LP-WUS MOs, or any combination thereof.

In some examples of the method, apparatus, and non-transitory computer-readable medium described herein, the first control message includes one or more indications of the first LP-WUS monitoring technique and the one or more LP-WUSs may be monitored in accordance with the first LP-WUS monitoring technique based on the one or more indications.

In some examples of the method, apparatus, and non-transitory computer-readable medium described herein, the one or more indications includes a variable, a first value of the variable indicates the first LP-WUS monitoring technique, and a second value of the variable indicates the second LP-WUS monitoring technique.

In some examples of the method, apparatus, and non-transitory computer-readable medium described herein, the second control message indicates the switch between the first LP-WUS monitoring technique and the second LP-WUS monitoring technique via an indication that the first LP-WUS monitoring technique, the second LP-WUS monitoring technique, or both, may be activated.

In some examples of the method, apparatus, and non-transitory computer-readable medium described herein, the second control message includes a single-bit field indicative of the switch, a first value of the single-bit field indicates the first LP-WUS monitoring technique may be activated, and a second value of the single-bit field indicates the second LP-WUS monitoring technique may be activated.

In some examples of the method, apparatus, and non-transitory computer-readable medium described herein, the second control message includes a multi-bit field indicative of the switch, a first value of the multi-bit field indicates the first LP-WUS monitoring technique may be activated, a second value of the multi-bit field indicates the second LP-WUS monitoring technique may be activated, a third value of the multi-bit field indicates both the first LP-WUS monitoring technique and the second LP-WUS monitoring technique may be activated, and a fourth value of the multi-bit field indicates both the first LP-WUS monitoring technique and the second LP-WUS monitoring technique may be deactivated.

In some examples of the method, apparatus, and non-transitory computer-readable medium described herein, the second control message indicates the switch between the first LP-WUS monitoring technique and the second LP-WUS monitoring technique via an indication of a switch from the first LP-WUS monitoring technique to the second LP-WUS monitoring technique.

In some examples of the method, apparatus, and non-transitory computer-readable medium described herein, the second control message includes an indication of a downlink control channel monitoring duration.

In some examples of the method, apparatus, and non-transitory computer-readable medium described herein, the second control message may be associated with an LCID that indicates that the second control message may be associated with LP-WUS-based downlink control channel monitoring.

In some examples of the method, apparatus, and non-transitory computer-readable medium described herein, the second control message includes a MAC-CE message.

In some examples of the method, apparatus, and non-transitory computer-readable medium described herein, the second control message includes a MAC-CE message associated with an LCID that indicates the MAC-CE message is associated with LP-WUS-based downlink control channel monitoring.

In some examples of the method, apparatus, and non-transitory computer-readable medium described herein, the second control message includes an indication of a validity duration associated with the switch between the first LP-WUS monitoring technique and the second LP-WUS monitoring technique.

In some examples of the method, apparatus, and non-transitory computer-readable medium described herein, the first control message includes a first RRC IE indicative of the set of one or more parameters.

In some examples of the method, apparatus, and non-transitory computer-readable medium described herein, the set of one or more parameters may be independent of a second set of one or more parameters associated with the one or more DRX cycles.

In some examples of the method, apparatus, and non-transitory computer-readable medium described herein, the first LP-WUS monitoring technique may be associated with one or more of transmission of one or more downlink messages during one or more active durations of the one or more DRX cycles based on transmission of the one or more LP-WUSs or transmission of the one or more downlink messages during one or more inactive durations of the one or more DRX cycles based on transmission of the one or more LP-WUSs.

In some examples of the method, apparatus, and non-transitory computer-readable medium described herein, the second LP-WUS monitoring technique may be associated with one or more of transmission of one or more downlink messages during one or more active durations of the one or more DRX cycles based on transmission of the one or more LP-WUSs or transmission of the one or more downlink messages during one or more inactive durations of the one or more DRX cycles based on transmission of the one or more LP-WUSs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for switching between downlink control channel monitoring using wake-up signals and discontinuous reception (DRX) in accordance with one or more aspects of the present disclosure.

FIG. 2 shows an example of a network architecture that supports techniques for switching between downlink control channel monitoring using wake-up signals and DRX in accordance with one or more aspects of the present disclosure.

FIG. 3 shows an example of a wireless communications system that supports techniques for switching between downlink control channel monitoring using wake-up signals and DRX in accordance with one or more aspects of the present disclosure.

FIG. 4 shows example of timing diagrams that supports techniques for switching between downlink control channel monitoring using wake-up signals and DRX in accordance with one or more aspects of the present disclosure.

FIG. 5 shows examples of timing diagrams that supports techniques for switching between downlink control channel monitoring using wake-up signals and DRX in accordance with one or more aspects of the present disclosure.

FIG. 6 shows an example of a process flow that supports techniques for switching between downlink control channel monitoring using wake-up signals and DRX in accordance with one or more aspects of the present disclosure.

FIGS. 7 and 8 show block diagrams of devices that support techniques for switching between downlink control channel monitoring using wake-up signals and DRX in accordance with one or more aspects of the present disclosure.

FIG. 9 shows a block diagram of a communications manager that supports techniques for switching between downlink control channel monitoring using wake-up signals and DRX in accordance with one or more aspects of the present disclosure.

FIG. 10 shows a diagram of a system including a device that supports techniques for switching between downlink control channel monitoring using wake-up signals and DRX in accordance with one or more aspects of the present disclosure.

FIGS. 11 and 12 show block diagrams of devices that support techniques for switching between downlink control channel monitoring using wake-up signals and DRX in accordance with one or more aspects of the present disclosure.

FIG. 13 shows a block diagram of a communications manager that supports techniques for switching between downlink control channel monitoring using wake-up signals and DRX in accordance with one or more aspects of the present disclosure.

FIG. 14 shows a diagram of a system including a device that supports techniques for switching between downlink control channel monitoring using wake-up signals and DRX in accordance with one or more aspects of the present disclosure.

FIGS. 15 and 16 show flowcharts illustrating methods that support techniques for switching between downlink control channel monitoring using wake-up signals and DRX in accordance with one or more aspects of the present disclosure.

### DETAILED DESCRIPTION

Some wireless communications systems may support communication (e.g., transmission and/or reception) of low-power signals, such as low-power wake up signals (LP-WUS), to support UE power savings. For example, rather than monitoring for a physical downlink control channel (PDCCH) via a main radio (MR), a user equipment (UE) may monitor for a LP-WUS via a low-power wake up receiver (LP-WUR) and, once the LP-WUS is received, the UE may activate the MR to monitor for the PDCCH. In such cases, the LP-WUR may be associated with relatively lower power consumption than the MR, such that monitoring for the LP-WUS via the LP-WUR and then for the PDCCH via the MR after the LP-WUS is received (e.g., rather than only monitoring for the PDCCH via the MR) may reduce power consumption at the UE.

In some wireless communications systems, a UE may support LP-WUS-triggered PDCCH monitoring with a connected mode discontinuous reception (C-DRX) configuration. In such cases, the UE may support multiple LP-WUS-monitoring techniques with the C-DRX configuration. For example, a first LP-WUS monitoring technique (e.g., which may be referred to as Option 1-1) may be associated with monitoring for a PDCCH during an active duration of a C-DRX cycle based on reception of an LP-WUS. That is, the UE may monitor for an LP-WUS using the LP-WUR at least a threshold duration prior to an active duration of the C-DRX cycle and, if the UE receives an LP-WUS within the threshold duration, the UE may monitor for a PDCCH during the active duration using the MR. If the UE does not receive an LP-WUS at least the threshold duration prior to the active duration, the UE may refrain from monitoring for the PDCCH during the active duration (e.g., may not wake up the MR during the active duration). Monitoring for the PDCCH in accordance with the first LP-WUS monitoring technique may enable the UE to achieve additional power savings (e.g., in addition to power savings associated with the C-DRX configuration) by refraining from monitoring for the PDCCH during an active duration of a C-DRX cycle when the UE has not received a LP-WUS at least the threshold duration prior to the active duration. Additionally, or alternatively, the UE may support a second LP-WUS monitoring technique (e.g., which may be referred to as Option 1-2) associated with monitoring for a PDCCH during an inactive duration of a C-DRX cycle based on reception of an LP-WUS. That is, during the inactive duration of the C-DRX cycle, the UE may monitor for one or more LP-WUSs using the LP-WUR and, if the UE receives an LP-WUS, the UE may monitor for the PDCCH during the inactive duration of the C-DRX cycle using the MR. Monitoring for the PDCCH in accordance with the second LP-WUS monitoring technique may enable the UE to achieve decreased latency (e.g., as compared to the first LP-WUS monitoring technique, as compared to PDCCH monitoring without LP-WUSs) by enabling the UE to receive the PDCCH during an inactive duration of a C-DRX cycle (e.g., rather than only during the active duration).

In some examples, the UE may switch between the first LP-WUS monitoring technique and the second LP-WUS monitoring technique due to one or more performance thresholds (e.g., latency requirements), among other reasons. However, a configuration of respective LP-WUS monitoring occasions (MOs) associated with each LP-WUS monitoring technique may be different, such that switching between the first LP-WUS monitoring technique and the second LP-WUS monitoring may result in increased latency and signaling overhead due to reconfiguration of the UE (e.g., via radio resource control (RRC) signaling) based on the switch. For example, the UE may monitor for LP-WUSs in accordance with an LP-WUS configuration, where the LP-WUS configuration is based on a set of parameters associated with LP-WUS MOs. However, the first LP-WUS monitoring technique may be associated with a first set of values of the set of parameters and the second LP-WUS monitoring technique may be associated with a second set of values of the set of parameters. Thus, to switch from monitoring for one or more LP-WUSs in accordance with the first LP-WUS monitoring technique to monitoring for one or more LP-WUSs in accordance with the second LP-WUS monitoring technique, the UE may receive control signaling indicative of the second set of values of the set of parameters. The UE may thus reconfigure the LP-WUS configuration in accordance with the second set of values of the set of parameters. Similarly, to switch from monitoring for one or more LP-WUSs in accordance with the second LP-WUS monitoring technique to monitoring for one or more LP-WUSs in accordance with the first LP-WUS monitoring technique, the UE may receive control signaling indicative of the first set of values of the set of parameters, and the UE may reconfigure the LP-WUS configuration in accordance with the first set of values of the set of parameters. In either case, reception of the control signaling indicative of a respective set of values of the set of parameters may result in increased signaling overhead, and reconfiguration of the LP-WUS configuration in accordance with the respective set of values of the set of parameters may result in increased latency. That is, the first LP-WUS monitoring technique and the second LP-WUS monitoring technique having separate configurations of LP-WUS MOs and having to switch between the separate configurations may result in signaling overhead and an inefficient use of communications resources.

Accordingly, techniques described herein may support the efficient configuration of one or more parameters applicable to the first LP-WUS monitoring technique and the second LP-WUS monitoring technique to enable the UE to efficiently switch between the first LP-WUS monitoring technique and the second LP-WUS monitoring technique. That is, the described techniques support the indication of one or more parameters that are applicable to the first LP-WUS monitoring technique and the second LP-WUS monitoring technique. Additionally, or alternatively, the one or more parameters may be applicable to both the first LP-WUS monitoring technique and the second LP-WUS monitoring technique. According to one example, the UE may support both the first LP-WUS monitoring technique in which the UE monitors for one or more first LP-WUSs prior to an active duration of a C-DRX cycle, and the second LP-WUS monitoring technique in which the UE monitors for one or more second LP-WUSs during an inactive duration of the C-DRX cycle. Additionally, or alternatively, the UE may receive a single RRC information element (IE) indicating the one or more parameters used by the UE to determine one or more LP-WUS MOs. Because the one or more parameters are applicable to the first LP-WUS monitoring technique and the second LP-WUS monitoring technique, the UE may use the one or more LP-WUSs MOs to monitor for the one or more first LP-WUSs according to the first LP-WUS monitoring technique and to monitor for the one or more second LP-WUSs according to the second LP-WUS monitoring technique. In such cases, the one or more parameters may include a slot periodicity and offset associated with the one or more LP-WUS MOs, an offset associated with the one or more first LP-WUSs and the one or more second LP-WUSs, a duration associated with the one or more LP-WUS MOs, or any combination thereof. Additionally, in some cases, the first control message may include a variable indicating whether the UE is to monitor for the one or more first LP-WUSs according to the first LP-WUS monitoring technique or to monitor for the one or more second LP-WUSs according to the second LP-WUS monitoring technique.

The UE may receive a second control message, such as the MAC-CE command, indicative of a switch regarding one or more activated LP-WUS monitoring techniques. That is, the second control message may include a field indicating that the first type of LP-WUS monitoring technique is activated, the second type of LP-WUS monitoring technique is activated, both the first type and the second type are activated, or both the first type and the second type are de-activated. For example, the UE may monitor for the one or more first LP-WUSs according to the first LP-WUS monitoring technique and may receive the second control message indicating that the second type of LP-WUS monitoring technique is activated (e.g., a switch from the first LP-WUS monitoring technique to the second LP-WUS monitoring technique), both the first type and the second type are activated (e.g., a switch from the first LP-WUS monitoring technique to both the first LP-WUS monitoring technique and the second LP-WUS monitoring technique), or both the first type and the second type are deactivated (e.g., a switch from the first LP-WUS monitoring technique to neither the first LP-WUS monitoring technique and the second LP-WUS monitoring technique). After receiving the second control message, the UE may monitor for a LP-WUS-triggered PDCCH in accordance with the switch. That is, the UE may activate, deactivate, or both, one or more LP-WUS monitoring techniques in accordance with the second control message.

Enabling the UE to dynamically switch between the first LP-WUS monitoring technique and the second LP-WUS monitoring technique in accordance with the one or more parameters may enable the UE to switch between the first LP-WUS monitoring technique and the second LP-WUS monitoring technique without performing a reconfiguration procedure at the UE. For example, rather than relying on separate signaling that reconfigures LP-WUS MOs based on the switch between the first LP-WUS monitoring technique and the second LP-WUS monitoring technique, the UE may instead adjust which LP-WUS MOs are monitored based on the switch between the first LP-WUS monitoring technique and the second LP-WUS monitoring technique. For example, as described herein, the UE may determine a set of LP-WUS MOs based on the one or more parameters applicable to the first LP-WUS monitoring technique and the second LP-WUS monitoring technique. The UE may monitor for the one or more first LP-WUSs during one or more first LP-WUS MOs, from the set of LP-WUS MOs, according to the first LP-WUS monitoring technique, where the one or more first LP-WUS MOs are prior to an active duration of a C-DRX cycle. Further, the UE may monitor for the one or more second LP-WUSs during one or more second LP-WUS MOs, from the set of LP-WUS MOs, according to the first LP-WUS monitoring technique, where the one or more second LP-WUS MOs are during an inactive duration of the C-DRX cycle. As such, to switch between the first LP-WUS monitoring technique and the second LP-WUS monitoring technique, the UE may switch between monitoring for LP-WUSs during the one or more first LP-WUS MOs and the one or more second LP-WUS MOs, where the one or more first LP-WUS MOs and the one or more second LP-WUS MOs are part of the set of LP-WUS MOs determined based on the one or more parameters applicable to the first LP-WUS monitoring technique and the second LP-WUS monitoring technique (e.g., one or more parameters applicable to both the first LP-WUS monitoring technique and the second LP-WUS monitoring technique).

Additionally, switching between the first LP-WUS monitoring technique and the second LP-WUS monitoring technique without performing the reconfiguration procedure may enable the UE to dynamically adjust a frequency of LP-WUS monitoring (e.g., and thus PDCCH monitoring) in accordance with one or more communication scenarios. For example, in some cases, a quantity of traffic to be communicated to the UE may exceed a threshold, the traffic may be associated with a threshold latency, or both, such that the UE may switch to monitoring for the one or more LP-WUS in accordance with the second LP-WUS monitoring techniques (e.g., more frequently than the first LP-WUS monitoring technique) to enable the UE to receive PDCCH during the inactive duration. Conversely, the UE may be associated with a power level below a threshold power (e.g., may have low power), such that the UE may switch to monitoring for the one or more LP-WUS in accordance with the first LP-WUS monitoring techniques (e.g., less frequently than the second LP-WUS monitoring technique) to enable the UE to refrain from monitoring for the one or more LP-WUSs during the inactive duration, thus reducing power consumption.

Aspects of the disclosure are initially described in the context of wireless communications systems. Aspects of the disclosure are the described in the context of timing diagrams and a process flow. Aspects of the disclosure are further illustrated by and described with reference to apparatus diagrams, system diagrams, and flowcharts that relate to techniques for switching between downlink control channel monitoring during or outside of an active duration of a C-DRX cycle.

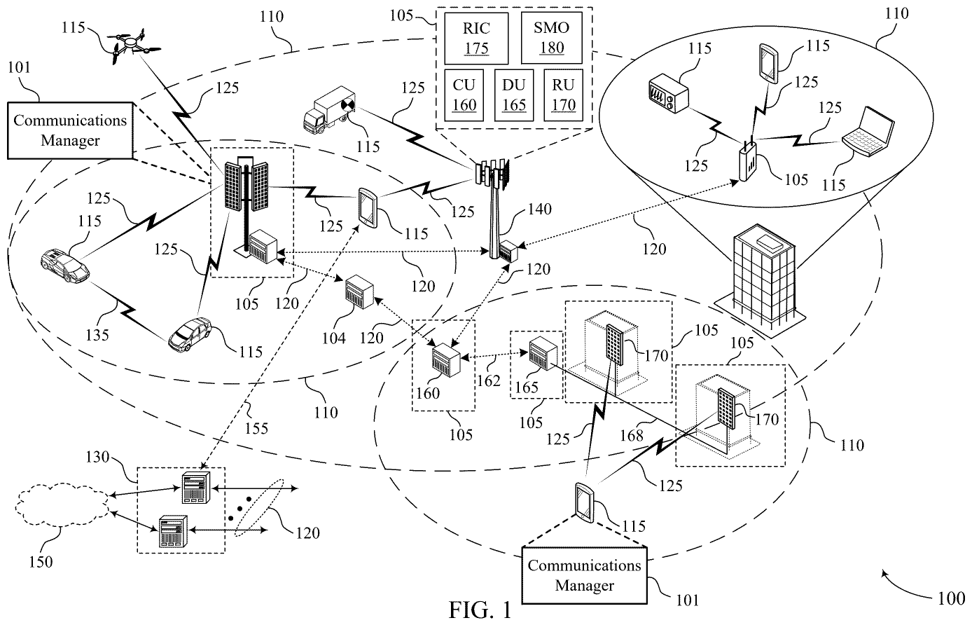

FIG. 1 shows an example of a wireless communications system 100 that supports techniques for switching between downlink control channel monitoring using wake-up signals and DRX in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for switching between downlink control channel monitoring using wake-up signals and DRX as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz 71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

One or more of the network entities 105 may include a communications manager 101, which may output a first control message that indicates a configuration of a set of one or more parameters applicable to a LP-WUS monitoring technique and a second LP-WUS monitoring technique that is different from the first low-power wake-up signal monitoring technique, output, based on one or more DRX cycles, one or more LP-WUSs in accordance with the set of one or more parameters and the first LP-WUS monitoring technique, output a second control message indicative of a switch between the first LP-WUS monitoring technique and the second LP-WUS monitoring technique, and output, based on the one or more DRX cycles, the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

One or more of the UEs 115 may include a communications manager 101, which may receive a first control message that indicates a configuration of a set of one or more parameters applicable to a LP-WUS monitoring technique and a second LP-WUS monitoring technique that is different from the first low-power wake-up signal monitoring technique, monitor, based on one or more DRX cycles, for one or more LP-WUSs in accordance with the set of one or more parameters and the first LP-WUS monitoring technique, receive a second control message indicative of a switch between the first LP-WUS monitoring technique and the second LP-WUS monitoring technique, and monitor, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

In some cases, the wireless communications system 100 may support efficient configuration of one or more parameters applicable to a first LP-WUS monitoring technique and a second LP-WUS monitoring technique. For example, the one or more parameters may be indicated via a same control message and may be applicable to both the first LP-WUS monitoring technique and the second LP-WUS monitoring technique. Such techniques may enable a UE 115 to efficiently switch between the first LP-WUS monitoring technique and the second LP-WUS monitoring technique, for example, based on a MAC-CE command, which may reduce latency and signaling overhead due to the one or more parameters enabling the UE 115 to refrain from performing a reconfiguration procedure based on the switch. That is, the UE 115 may support both the first LP-WUS monitoring technique and the second LP-WUS monitoring technique and may receive a first control message (e.g., a single RRC IE) indicative of the one or more parameters applicable to both the first LP-WUS monitoring technique and the second LP-WUS monitoring technique. In such cases, the one or more parameters may include a slot periodicity and offset associated with LP-WUS MOs, an offset associated with LP-WUSs, a duration associated with the LP-WUS MOs, or any combination thereof. Additionally, in some cases, the first control message may include a variable indicating which of the first type of LP-WUS-triggered PDCCH monitoring or the second type of LP-WUS-triggered PDCCH monitoring the UE 115 is to use to monitor for LP-WUS-triggered PDCCH (e.g., initially).

The UE 115 may receive a second control message, such as the MAC-CE command, indicative of a switch between the first LP-WUS monitoring technique and the second type of LP-WUS monitoring technique. For example, the second control message may include a field indicating the first type of LP-WUS monitoring technique is activated, the second type of LP-WUS monitoring technique is activated, both the first type and the second type are activated, or both the first type and the second type are de-activated. After receiving the second control message, the UE 115 may monitor for LP-WUS-triggered PDCCH in accordance with the switch.

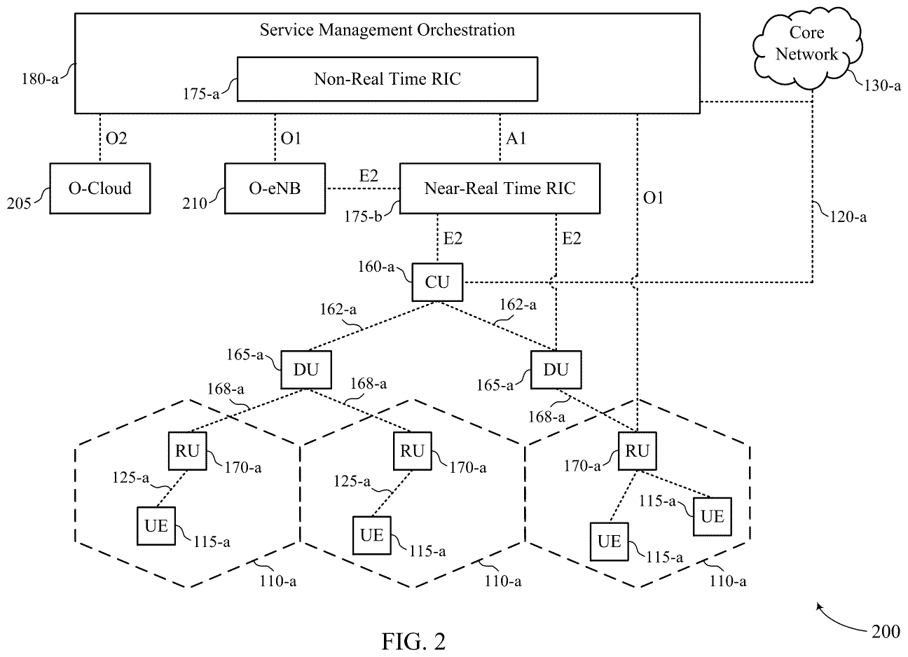

FIG. 2 shows an example of a network architecture 200 (e.g., a disaggregated base station architecture, a disaggregated RAN architecture) that supports techniques for switching between downlink control channel monitoring using wake-up signals and DRX in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some cases, the network architecture 200 In some cases, may support efficient configuration of one or more parameters applicable to a first LP-WUS monitoring technique and a second LP-WUS monitoring technique. For example, the one or more parameters may be indicated via a same control message and may be applicable to both the first LP-WUS monitoring technique and the second LP-WUS monitoring technique. Such techniques may enable a UE 115 to efficiently switch between the first LP-WUS monitoring technique and the second LP-WUS monitoring technique, for example, based on a MAC-CE command, which may reduce latency and signaling overhead due to the one or more parameters enabling the UE 115 to refrain from performing a reconfiguration procedure based on the switch. That is, the UE 115 may support both the first LP-WUS monitoring technique and the second LP-WUS monitoring technique and may receive a first control message (e.g., a single RRC IE) indicative of the one or more parameters applicable to the first LP-WUS monitoring technique and the second LP-WUS monitoring technique. In such cases, the one or more parameters may include a slot periodicity and offset associated with LP-WUS MOs, an offset associated with LP-WUSs, a duration associated with the LP-WUS MOs, or any combination thereof. Additionally, in some cases, the first control message may include a variable indicating which of the first type of LP-WUS-triggered PDCCH monitoring or the second type of LP-WUS-triggered PDCCH monitoring the UE 115 is to use to monitor for LP-WUS-triggered PDCCH (e.g., initially).

The UE 115 may receive a second control message, such as the MAC-CE command, indicative of a switch between the first LP-WUS monitoring technique and the second type of LP-WUS monitoring technique. For example, the second control message may include a field indicating the first type of LP-WUS monitoring technique is activated, the second type of LP-WUS monitoring technique is activated, both the first type and the second type are activated, or both the first type and the second type are de-activated. After receiving the second control message, the UE 115 may monitor for LP-WUS-triggered PDCCH in accordance with the switch.

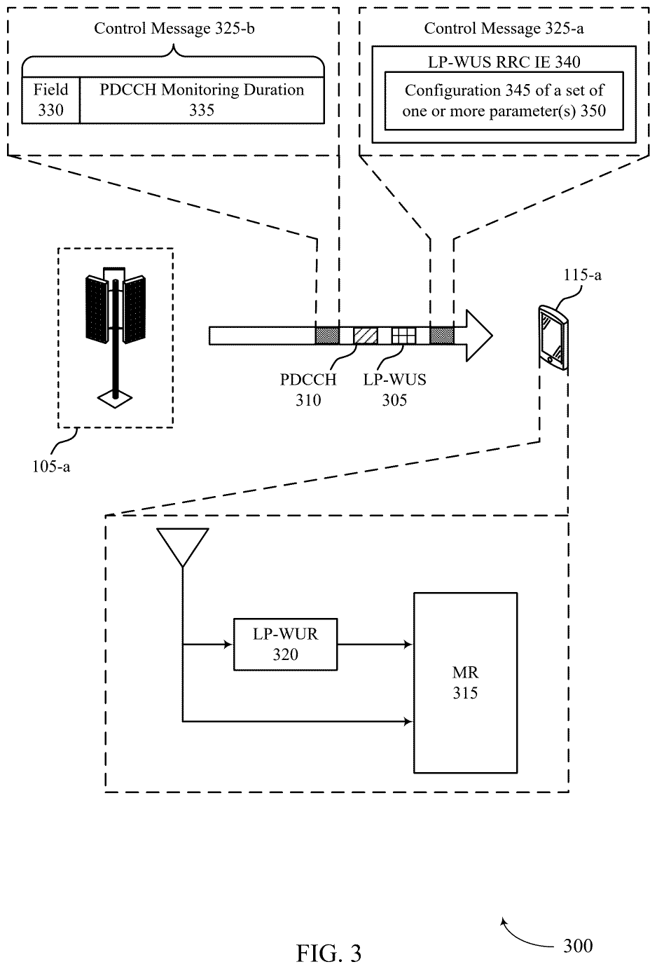

FIG. 3 shows an example of a wireless communications system 300 that supports techniques for switching between downlink control channel monitoring using wake-up signals and DRX in accordance with one or more aspects of the present disclosure. In some cases, the wireless communications system 300 may implement or be implemented by aspects of the wireless communications system 100, the network architecture 200, or both. For example, the wireless communications system 300 may include one or more UEs 115 (e.g., a UE 115-a) and one or more network entities 105 (e.g., a network entity 105-a), which may be examples of the corresponding devices as described herein.

In some cases, a UE 115, such as the UE 115-a, may support LP-WUS-triggered PDCCH monitoring. That is, the UE 115-a may include (e.g., support) both a first radio component (e.g., receiver), which may be referred to as a LP-WUR 320 (e.g., low-power wake-up radio), and a second radio component, which may be referred to as an MR 315 (e.g., main radio), where the LP-WUR 320 may have reduced complexity, reduced capability, or reduced power consumption relative to the MR 315, such that the LP-WUR 320 may be associated with (e.g., use) a lower power consumption than the MR 315. However, the LP-WUR 320 may not have the capability to perform transmissions. In such cases, the UE 115-a may have the capability to switch the LP-WUR 320 on and off quickly (e.g., within a threshold duration), and may have the capability to receive and process simple signals, such as signals associated with a threshold bandwidth (e.g., a limited bandwidth), signals associated with one or more waveforms (e.g., simple waveforms, on off keying (OOK) waveforms), or both, via the LP-WUR 320.

For example, the UE 115-a may turn off the MR 315 (e.g., to save power while the UE 115-a is in a deep sleep mode) and, while the MR 315 is off, may monitor for one or more LP-WUSs 305 via the LP-WUR 320. If the UE 115-a receives an LP-WUS 305 from the network entity 105-a via the LP-WUR 320, the UE 115-a may wake up (e.g., turn on, supply power to) the MR 315 and may monitor for (e.g., and receive) a control message 325 via a PDCCH 310 (e.g., from the network entity 105-a via the MR 315). In other words, the UE 115-a may perform LP-WUS-triggered PDCCH monitoring using the MR 315 based on reception of the LP-WUS 305 via the LP-WUR 320. As described herein, the UE 115-a may monitor for the one or more LP-WUSs 305 via the LP-WUR 320 in a deep sleep mode (e.g., a first mode) and may wake up the MR 315 and monitor for the control message 325 in an awake mode (e.g., a second mode). In other words, the UE 115-a may operate according to the deep sleep mode when monitoring for the one or more LP-WUSs 305 via the LP-WUR 320 (e.g., may use the LP-WUR 320 in the deep sleep mode) and may operate according to the awake mode when monitoring for the control message 325 via the MR 315 (e.g., may use the MR 315 in the awake mode).

In some examples, the UE 115-a may support OOK modulation for reception of LP-WUSs 305 (e.g., and low-power synchronization signals (LP-SSs)). For example, the UE 115-a may support OOK-1, OOK-4, or both, for reception of the LP-WUSs 305. In baseband, an OOK waveform may be a sequence of high power (e.g., high amplitude, first threshold power) durations or low (e.g., low amplitude, zero power, second threshold power) durations. In such cases, a high power duration, a low power duration, or both, may convey an information bit. For example, in an OOK waveform, a zero amplitude duration (e.g., off duration) may indicate a bit value of zero and a high amplitude duration (e.g., on duration) may indicate a bit value of 1.

In some cases, when an OFDM sequence (e.g., Gold sequence, M sequence, computer searched sequence, Zadoff Chu sequence) is overlaid with OOK-1 modulation, the network entity 105-a have the capability to convey 1 bit of information in one OFDM symbol (e.g., using an amplitude of am OOK-1 waveform). Similarly, when an OFDM sequence is overlaid with OOK-4 modulation, the network entity 105-a may have the capability to convey M bits of information in one OFDM symbol (e.g., using an amplitude of am OOK-4 waveform). For example, when M=2, the network entity 105-a may be capable of communicating 2 OOK symbols per OFDM symbol. In another example, when M=4, the network entity 105-a may be capable of communicating 4 OOK symbols per OFDM symbol.

In some cases, the UE 115-a may additionally support C-DRX (e.g., for UE power savings) in which the UE 115-a may periodically wake up to monitor the PDCCH 310 for a control message 325 from the network entity 105-a. That is, the UE 115-a may support one or more C-DRX cycles, where each C-DRX cycle includes an active duration (e.g., on duration, active time, when an on duration timer is running) during which the UE 115-a may monitor the PDCCH 310 for the control message 325 and an inactive duration (e.g., off duration, inactive time, when the on duration timer is not running) during which the UE 115-a may enter a sleep mode (e.g., refrain from monitoring the PDCCH 310 for the control message 325). However, a periodicity of active durations (e.g., in the one or more C-DRX cycles, of PDCCH monitoring) may be fixed (e.g., configured by the network entity 105-a), such that the UE 115-a may wake up and monitor for the PDCCH 310 during each active duration (e.g., on the one or more C-DRX cycles), even when the network entity 105-a does not transmit a control message to the UE 115-a (e.g., during an active duration), which may reduce power savings and latency performance.

Accordingly, in some cases, the UE 115-a (e.g., in an RRC CONNECTED mode) may support PDCCH monitoring triggered by LP-WUSs 305 (e.g., LP-WUS-based PDCCH monitoring) with a C-DRX configuration. In some cases, the UE 115-a may support a first LP-WUS monitoring technique (e.g., a first type of LP-WUS monitoring, a first type of LP-WUS-triggered PDCCH monitoring) with the C-DRX configuration, which may be referred to as Option 1-1 as described further with reference to a timing diagram 400-a and a timing diagram 500-a, may support a second LP-WUS monitoring technique (e.g., a second type of LP-WUS monitoring, a second type of LP-WUS-triggered PDCCH monitoring), which may be referred to as Option 1-2 as described further with reference to a timing diagram 400-b and a timing diagram 500-b, or may support both Option 1-1 and Option 1-2.

According to Option 1-1, the UE 115-a may monitor for one or more LP-WUSs 305 (e.g., according to a first LP-WUS monitoring configuration) before an active duration of a C-DRX cycle (e.g., before a drx-onDurationTimer is running) and, if the UE 115-a receives an LP-WUS 305 (e.g., via the LP-WUR 320), the UE 115-a may trigger a start of the active duration. That is, if the UE 115-a receives the LP-WUS 305 within a threshold duration of the active duration, the UE 115-a may turn on the MR 315 (e.g., wake up) during the active duration to monitor for a control message 325 via the PDCCH 310. Conversely, if the UE 115-a does not receive the LP-WUS 305 within the threshold duration of the active duration, the UE 115-a may stay in the sleep mode and may refrain from turning on the MR 315 (e.g., refrain from waking up, refrain from monitoring the PDCCH 310 for the control message 325 during the active duration).

According to Option 1-2, the UE 115-a may monitor for one or more LP-WUSs 305 (e.g., according to a second LP-WUS monitoring configuration) during an inactive duration of a C-DRX cycle (e.g., outside of an active duration of the C-DRX cycle) and, if the UE 115-a receives an LP-WUS 305 (e.g., via the LP-WUR 320), the UE 115-a may turn on the MR 315 to monitor for a control message 325 via the PDCCH 310. That is, if the UE 115-a receives the LP-WUS 305 during the inactive duration, the UE 115-a may turn on the MR 315 to monitor for the control message 325 via the PDCCH 310 during the inactive duration (e.g., even though the UE 115-a is in the inactive duration of the C-DRX cycle). Conversely, if the UE 115-a does not receive the LP-WUS 305 during the inactive duration, the UE 115-a may remain in the sleep mode and may refrain from turning on the MR 315 (e.g., refrain from waking up, refrain from monitoring for the PDCCH 310).

In some examples, the UE 115-a may support both Option 1-1 and Option 1-2 and, in some cases, may switch between Option 1-1 and Option 1-2. For example, Option 1-2 may be associated with relatively lower latency than Option 1-1 based on a capability of the UE 115-a to perform PDCCH monitoring (e.g., triggered by an LP-WUS 305) during an inactive duration of a C-DRX cycle in accordance with Option 1-2. The UE 115-a may switch from Option 1-1 to Option 1-2 based on data to be received by the UE 115-a being associated with a threshold latency (e.g., being associated with a latency requirement not satisfied by Option 1-1). However, Option 1-1 may be associated with a first LP-WUS configuration (e.g., one or more first parameters associated with the one or more LP-WUSs 305) and Option 1-2 may be associated with a second LP-WUS configuration (e.g., one or more second parameters associated with the one or more LP-WUSs 305), where the first LP-WUS configuration is different than the second LP-WUS configuration (e.g., the one or more first parameters are different than the one or more second parameters). To switch between Option 1-1 and Option 1-2, the UE 115-a may switch between the first LP-WUS configuration and the second LP-WUS configuration, which may result in increased latency and signaling overhead. In other words, the UE 115-a may perform a reconfiguration procedure to switch between Option 1-1 and Option 1-2, which may result in increased latency and signaling overhead.

Techniques described herein may enable the UE 115-a to support one or more shared parameters 350 (e.g., a shared LP-WUS configuration 345) applicable to Option 1-1 and Option 1-2 (e.g., to both Option 1-1 and Option 1-2) to enable the network entity 105-a to dynamically (e.g., efficiently) switch the UE 115-a between Option 1-1 and Option 1-2, resulting in decreased latency and decreased overhead (e.g., without additional configuration signaling). For example, the UE 115-a may receive a control message 325-a (e.g., including a LP-WUS RRC IE 340) indicating a configuration 345 of one or more shared parameters 350 applicable to MOs associated with the one or more LP-WUSs 305, which may be referred to as LP-WUS MOs, for Option 1-1 and Option 1-2 (e.g., for both Option 1-1 and Option 1-2). That is, rather than supporting one or more first parameters associated with Option 1-1 and one or more second parameters for Option 1-2, the UE 115-a may support a single set of one or more shared parameters 350 applicable to LP-WUS MOs for Option 1-1 and Option 1-2 (e.g., the first LP-WUS configuration may be the same as the second LP-WUS configuration, the UE 115-a may support a shared LP-WUS configuration). In some other cases, the UE 115-a may support the one or more first parameters and the one or more second parameters, where the one or more first parameters are different than the one or more second parameters.

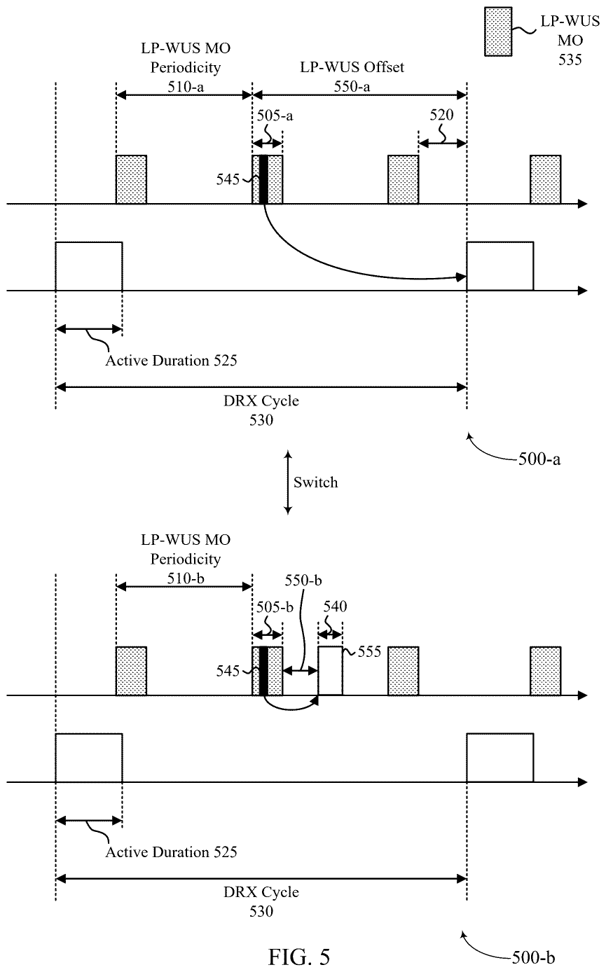

The one or more shared parameters 350 may include an LP-WUS MO periodicity (e.g., LPWUS-SlotPeriodicityAndOffset), an LP-WUS MO duration (e.g., LPWUS-duration), an LP-WUS offset (e.g., LPWUS-offset), a PDCCH monitoring duration 335 (e.g., LPWUS-PDCCH-timer), or any combination thereof, as described further with reference to FIG. 5. The one or more shared parameters 350 associated with the one or more LP-WUS MOs (e.g., the LP-WUS RRC IE 340) may be independent from one or more other parameters associated with the one or more C-DRX cycles (e.g., the network entity 105-a may indicate the shared LP-WUS configuration in a different RRC IE than the C-DRX configuration, the one or more shared parameters 350 may not depend on the one or more other parameters).

Additionally, or alternatively, the control message 325-a (e.g., including the LP-WUS RRC IE 340) may include an indication of which of Option 1-1 or Option 1-2 the UE 115-a is to use for monitoring for (e.g., initially monitor for) one or more LP-WUSs 305. For example, the control message 325-a may include a variable (e.g., LPWUSMO-option) indicating Option 1-1 or Option 1-2. That is, a first value of the variable (e.g., 1) may indicate for (e.g., command) the UE 115-a to monitor for the one or more LP-WUSs 305 according to Option 1-1 and a second value of the variable (e.g., 2) may indicate for the UE 115-a to monitor for the one or more LP-WUSs 305 according to Option 1-2, such that the control message 325-a may indicate the first value of the variable or the second value of the variable. For example, if LP-WUS monitoring is configured with the variable (e.g., LPWUSMO-option) set to Option 1-1 (e.g., via the first value), the UE 115-a may monitor for one or more LP-WUSs 305 in accordance with Option 1-1. Conversely, if LP-WUS monitoring is configured with the variable (e.g., LPWUSMO-option) set to Option 1-2 (e.g., via the second value), the UE 115-a may monitor for the one or more LP-WUSs 305 in accordance with Option 1-2. In some examples, an Option (e.g., a LP-WUS MO Option) indicated by the variable may be referred to as a default Option. That is, either Option 1-1 or Option 1-2 may be the default Option, as indicated by the control message 325-a.

Thus, the UE 115-a may monitor for (e.g., initially monitor for) the one or more LP-WUSs 305 according to Option 1-1 or Option 1-2 (e.g., as indicated by a value of the variable) and may receive a control message 325-b (e.g., MAC-CE message, command) that activates (e.g., or deactivates) Option 1-1, Option 1-2, or both. In some cases, the control message 325-b may indicate a switch between Option 1-1 and Option 1-2. That is, the second control message may indicate either a first switch from Option 1-1 to Option 1-2 or a second switch from Option 1-2 to Option 1-1.

Additionally, or alternatively, the second control message may indicate which of Option 1-1 or Option 1-2 (e.g., or both, or neither) are activated (e.g., to be activated, to be used by the UE 115-a for monitoring of LP-WUSs 305). For example, in some cases, the control message 325-b may include a single bit field 330 indicating that either Option 1-1 or Option 1-2 is activated. That is, a first value of the single bit field 330 may activate Option 1-1 and a second value of the single bit field 330 may activate Option 1-2. In some other examples, the control message 325-b may include a multi-bit field 330 (e.g., 2 bits) indicating Option 1-1 being activated, Option 1-2 being activated, both Option 1-1 and Option 1-2 being activated, or both Option 1-1 and Option 1-2 being de-activated. For example, a first value of the multi-bit field 330 may activate Option 1-1, a second value of the multi-bit field 330 may activate Option 1-2, a third value of the multi-bit field 330 may activate both Option 1-1 and Option 1-2, and a fourth value of the multi-bit field 330 may de-activate both Option 1-1 and Option 1-2. In some cases, the single bit field 330 or the multi-bit field 330 may be a first field 330 in the control message 325-b (e.g., a first field of 1 or 2 bits in a first Octet).

Thus, if LP-WUS monitoring is configured with Option 1-1 activated via the control message 325-b, the UE 115-a may monitor for the one or more LP-WUSs 305 in accordance with Option 1-1. Conversely, if LP-WUS monitoring is configured with Option 1-2 activated via the control message 325-b, the UE 115-a may monitor for the one or more LP-WUSs 305 in accordance with Option 1-2. In such cases, reception of a LP-WUS 305 (e.g., LP-WUS indication received from a lower layer) may indicate for the UE 115-a to start a timer associated with the PDCCH monitoring duration 335 (e.g., LPWUS-PDCCH-timer). In another example, if LP-WUS monitoring is configured with Option 1-1 and Option 1-2 activated via the control message 325-b, the UE 115-a may monitor for the one or more LP-WUSs 305 in accordance with Option 1-1 and Option 1-2. Conversely, if LP-WUS monitoring is configured with Option 1-1 and Option 1-2 de-activated via the control message 325-b, the UE 115-a may refrain from monitoring for the one or more LP-WUSs 305 in accordance with Option 1-1 and Option 1-2.

Additionally, in some cases, the control message 325-b may include an indication of the PDCCH monitoring duration 335 (e.g., PDCCH monitoring timer, a MAC timer). In some examples, such as when neither the control message 325-a nor the control message 325-b includes an indication of the PDCCH monitoring duration 335, the UE 115-a may set the PDCCH monitoring duration 335 equal to a value of an on duration timer associated with the C-DRX configuration (e.g., drx-OnDurationTimer).

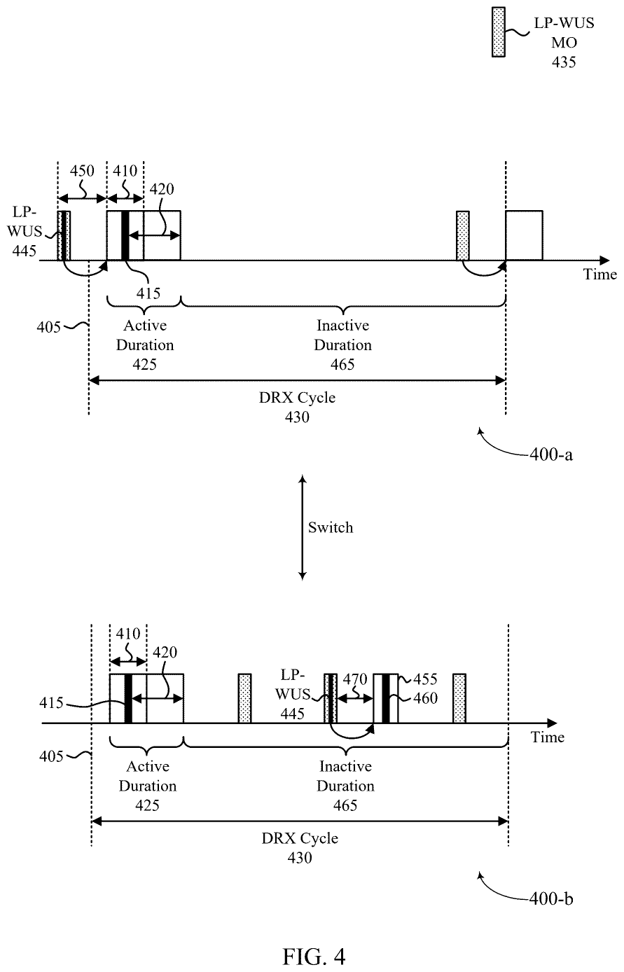

FIG. 4 shows examples of timing diagrams 400 (e.g., the timing diagram 400-a and the timing diagram 400-b) that supports techniques for switching between downlink control channel monitoring using wake-up signals and DRX in accordance with one or more aspects of the present disclosure. In some cases, the timing diagrams 400 may implement or be implemented by aspects of the wireless communications system 100, the network architecture 200, the wireless communications system 300, or any combination thereof. For example, the timing diagrams 400 may be implemented by one or more UEs 115 and one or more network entities 105, which may be examples of the corresponding devices as described herein.

As described with reference to FIG. 3, the timing diagram 400-a may depict an example of a DRX cycle 430 with LP-WUS monitoring in accordance with Option 1-1 and the timing diagram 400-b may depict an example of the DRX cycle 430 with LP-WUS monitoring in accordance with Option 1-2. The DRX cycle 430 may be an example of a C-DRX cycle (e.g., C-DRX period) described herein, or may be utilized instead of the C-DRX cycle described herein. In some cases, DRX cycle 430 may start at 405, which may correspond to a beginning of a subframe (e.g., a starting subframe based on drx-LongCycleStartOffset) and, as illustrated in FIG. 4, the DRX cycle 430 may include an active duration 425 (e.g., active time) and an inactive duration 465 (e.g., inactive time, during which a UE 115 may sleep). The active duration 425 may begin at a slot offset (e.g., drx-SlotOffset) from the beginning of the subframe (e.g., from 405).

The active duration 425 may include a duration 410 associated with a first timer (e.g., during which a drx-OnDurationTimer is running) and, optionally, a duration 420 associated with a second timer (e.g., during which a drx-InactivityTimer is running). In some cases, the active duration 425 may include both the duration 410 and the duration 420 when a UE 115 receives a PDCCH 415 indicating a transmission (e.g., a subsequent downlink, uplink, or sidelink data transmission on a serving cell in a DRX group) during the duration 410 (e.g., while the drx-OnDurationTimer is running), where the duration 420 extends from the PDCCH 415, such that the active duration 525 ends at the end of the duration 420 (e.g., ends when the drx-InactivityTimer expires). In other words, the duration 410 may begin when the first timer is triggered by the beginning of the active duration 425 and the duration 420 may begin when the second timer is triggered by reception of the PDCCH 415 while the first timer is running.

In some examples (e.g., not depicted), the second timer (e.g., the drx-InactivityTimer) may restart based on reception of another PDCCH 415 prior to the end of the duration 420. That is, the UE 115 may receive a first PDCCH 415 triggering the start of the second timer and, if a second PDCCH 415 is received while the second timer is running, the UE 115 may restart the second timer from a time at which the second PDCCH 415 was received. Conversely, the active duration 425 may include the duration 410 (e.g., and not the duration 420) when the UE 115 does not (e.g., fails to) receives the PDCCH 415 during the duration 410, such that the active duration 425 ends at the end of the duration 410 (e.g., ends when the drx-OnDurationTimer expires). In other words, the UE 115 may be in the active duration 425 of the DRX cycle 430 when either the first timer (e.g., the drx-OnDurationTimer) or the second timer (e.g., the drx-InactivityTimer) is running.

As described with reference to FIG. 2, the UE 115 may support LP-WUS monitoring in accordance with Option 1-1 and in accordance with Option 1-2. For example, as depicted in the timing diagram 400-a, the UE 115 may perform LP-WUS monitoring in accordance with Option 1-1. That is, the UE 115 may monitor for one or more LP-WUS MOs 435 (e.g., in accordance with the one or more shared parameters as described with reference to FIG. 3) within a threshold duration 450 of the active duration 425 of the DRX cycle 430 (e.g., prior to a slot in which the drx-OnDurationTimer is to start) and, if the UE 115 receives (e.g., and a network entity 105 transmits) an LP-WUS 445 during the one or more LP-WUS MOs 435, the UE 115 may monitor for a PDCCH 415 during the active duration 425 (e.g., may start the drx-OnDurationTimer during the active duration 425). That is, the UE 115 may monitor for the PDCCH 415 during the active duration 425 (e.g., may trigger the drx-OnDurationTimer) based on receiving the LP-WUS 445 during the one or more LP-WUS MOs 435 within the threshold duration 450 prior to the active duration 425. Conversely, if the UE 115 does not (e.g., fails to) receive (e.g., and the network entity 105 does not transmit) the LP-WUS 445 during the one or more LP-WUS MOs 435, the UE 115 may refrain from monitoring for the PDCCH 415 during the active duration 425. That is, the UE 115 may refrain from monitoring for the PDCCH 415 during the active duration 425 based on failure to receive the LP-WUS 445 during the one or more LP-WUS MOs 435 within the threshold duration 450 prior to the active duration 425.

Additionally, or alternatively, as depicted in the timing diagram 400-b, the UE 115 may perform LP-WUS monitoring in accordance with Option 1-2. That is, the UE 115 may monitor for one or more LP-WUS 445 (e.g., in accordance with the one or more shared parameters as described with reference to FIG. 3) during one or more LP-WUS MOs 435 during the inactive duration 465 of the DRX cycle 430 (e.g., outside of the active duration 425 of the DRX cycle 430). In such cases, if the UE 115 receives an LP-WUS 445 during an LP-WUS MO 435 during the inactive duration, the UE 115 may trigger PDCCH monitoring (e.g., a PDCCH MO 455). That is, the UE 115 may monitor for a PDCCH 460 during a PDCCH MO 455 based on reception of the LP-WUS 445 during the LP-WUS MO 435 (e.g., during the inactive duration). In such cases, the PDCCH MO 455 may occur at an offset 470 (e.g., a fixed offset in time) from the LP-WUS MO 435 in which the UE 115 receives the LP-WUS 445. In some aspects, the PDCCH MO 455 may occur during a duration (e.g., PDCCH monitoring duration) in which a timer is running, which may be referred to as a PDCCH monitoring duration timer. For instance, reception of the LP-WUS 445 may trigger the PDCCH monitoring duration timer to begin running after the offset 470.

In accordance with Option 1-2 (e.g., when Option 1-2 is activated and Option 1-1 is deactivated), as depicted in the timing diagram 400-b, monitoring for a PDCCH 415 during a duration 410 may be independent from LP-WUS monitoring. That is, the UE 115 may monitor for the PDCCH 415 during the duration 410 regardless of whether an LP-WUS 445 is received during an LP-WUS MO 435 within the threshold duration 450 prior to the active duration 425. In such cases, monitoring for the PDCCH 415 during the duration 410 may be based on starting the first timer at the beginning of the active duration 425 (e.g., in accordance with the slot offset), may be based on reception of a downlink control information of power saving (DCP) signal (e.g., via a MR, not an LP-WUR) at a DCP offset (e.g., ps-Offset-r16) prior to the active duration 425, or both. In such cases, the DCP offset may be a start of a search time of a control message (e.g., DCI format 2-6 with cyclic redundancy check (CRC) scrambled by a power saving radio network temporary identifier (PS-RNTI)) and may be relative to a start of the first timer (e.g., the drx-OnDurationTimer of Long DRX).

As described with reference to FIG. 3, the network entity 105 may indicate for the UE 115 to switch between LP-WUS monitoring in accordance with Option 1-1, LP-WUS monitoring in accordance with Option 1-2, LP-WUS monitoring in accordance with Option 1-1 and Option 1-2, and LP-WUS monitoring in accordance with neither Option 1-1 nor Option 1-2. That is, the network entity 105 may transmit, to the UE 115, a control message (e.g., MAC-CE) indicating which of Option 1-1, Option 1-2, both Option 1-1 and Option 1-2, or neither of Option 1-1 and Option 1-2 with which the UE 115 is to perform LP-WUS monitoring. For example, if the control message indicates Option 1-1, the UE 115 may perform LP-WUS monitoring in accordance with the timing diagram 400-a, if the control message indicates Option 1-2, the UE 115 may perform LP-WUS monitoring in accordance with the timing diagram 400-b, if the control message indicates both Option 1-1 and Option 1-2, the UE 115 may perform LP-WUS monitoring in accordance with the timing diagram 400-a and the timing diagram 400-b, and if the control message indicates neither of Option 1-1 and Option 1-2 (e.g., indicates Option 1-1 and Option 1-2 are deactivated), the UE 115 may refrain from performing LP-WUS monitoring in accordance with the timing diagram 400-a and the timing diagram 400-b.

When performing LP-WUS monitoring in accordance with both Option 1-1 and Option 1-2, the UE 115 may monitor for one or more LP-WUS 445 within the threshold duration 450 of the active duration 425 and during the inactive duration 465. That is, the UE 115 may monitor for a PDCCH 415 during the active duration 425 based on reception of an LP-WUS 445 within the threshold duration 450 of the active duration 425 and may monitor for a PDCCH 460 during the inactive duration 465 based on reception of an LP-WUS 445 during the inactive duration 465.

FIG. 5 shows examples of timing diagrams 500 (e.g., the timing diagram 500-a and the timing diagram 500-b) that supports techniques for switching between downlink control channel monitoring using wake-up signals and DRX in accordance with one or more aspects of the present disclosure. In some cases, the timing diagrams 500 may implement or be implemented by aspects of the wireless communications system 100, the network architecture 200, the wireless communications system 300, the timing diagrams 400, or any combination thereof. For example, the timing diagrams 500 may be implemented by one or more UEs 115 and one or more network entities 105, which may be examples of the corresponding devices as described herein.

As described with reference to FIGS. 3 and 5, the timing diagram 500-a may depict an example of a DRX cycle 530 (e.g., C-DRX cycle) with LP-WUS monitoring in accordance with Option 1-1 and the timing diagram 500-b may depict an example of the DRX cycle 530 with LP-WUS monitoring in accordance with Option 1-2. As described herein, the DRX cycle 530 may include an active duration 525 (e.g., associated with a drx-OnDurationTimer and/or a drx-InactivityTimer).

As described with reference to Option 1-1 depicted in the timing diagram 500-a, the UE 115 may perform LP-WUS monitoring in accordance with a first set of one or more parameters. In such cases, the first set of one or more parameters may include an LP-WUS MO duration 505-a (e.g., LPWUS-duration), a threshold time gap 520 (e.g., MinTimeGap-LPWUS), an LP-WUS offset 550-a (e.g., LPWUS-offset), an LP-WUS MO periodicity 510-a (e.g., LPWUS-SlotPeriodicityAndOffset), a first LP-WUS MO offset (e.g., LPWUS-SlotPeriodicityAndOffset), or any combination thereof. The LP-WUS MO duration 505-a may define a first duration (e.g., a quantity of consecutive slots with a start time that is based on LPWUS-SlotPeriodicityAndOffset) associated with each LP-WUS MO 535 during which the UE 115 is to monitor for an LP-WUS 545. The threshold time gap 520 may define a gap (e.g., in time, a quantity of slots, or the like) prior to an active duration 525 in which the UE 115 may not receive an LP-WUS 545 triggering PDCCH monitoring in the active duration 525. That is, the UE 115 may monitor for a PDCCH during the active duration 525 if an LP-WUS 545 is received prior to the threshold time gap 520 (e.g., between the LP-WUS offset 550 and the threshold time gap 520) and may not monitor for the PDCCH during the active duration 525 if the LP-WUS 545 is received within the threshold time gap 520. The LP-WUS offset 550-a (e.g., in the context of Option 1-1) may indicate a time (e.g., an instance, a slot) where the UE 115-a is to start monitoring for LP-WUSs 545 prior to a slot where the active duration 525 is to start. That is, the UE 115 may monitor for a PDCCH during the active duration 525 if an LP-WUS 545 is received within the LP-WUS offset 550 (e.g., between the LP-WUS offset 550 and the threshold time gap 520) and may not monitor for the PDCCH during the active duration 525 if the LP-WUS 545 is received prior to the LP-WUS offset 550. The LP-WUS MO periodicity 510-a and the first LP-WUS MO offset may define (e.g., be used by the UE 115 to calculate) a start of each LP-WUS MO 535.

In some cases (e.g., Option 1-1, Approach 1), the network entity 105-a may configure LP-WUS MOs 535 (e.g., including the LP-WUS MO periodicity 510-a and the first LP-WUS MO offset) independently from a DRX periodicity and a DRX offset. That is, the LP-WUS MOs 535 may be defined by the LP-WUS MO periodicity 510-a and the first LP-WUS MO offset (e.g., one or more LP-WUS MOs 535 prior to an active duration 525 can trigger PDCCH monitoring). In some other cases (e.g., Option 1-1, Approach 2), the network entity 105-a may configure LP-WUS MOs 535 (e.g., including the LP-WUS MO periodicity 510-a and the first LP-WUS MO offset) based on a slot during which an active duration 525 is to start (e.g., a slot that the drx-onDurationTimer would start). That is, the LP-WUS MOs 535 may be defined by a time offset prior to the start of an active duration 525 (e.g., one LP-WUS MO 535 prior to an active duration 525 can trigger PDCCH monitoring).

As described with reference to Option 1-2 depicted in the timing diagram 500-b, the UE 115 may perform LP-WUS monitoring in accordance with a second set of one or more parameters. In such cases, the second set of one or more parameters may include an LP-WUS MO duration 505-b (e.g., LPWUS-duration), an LP-WUS offset 550-b (e.g., LPWUS-offset), an LP-WUS MO periodicity 510-b (e.g., LPWUS-SlotPeriodicityAndOffset), a second LP-WUS MO offset (e.g., LPWUS-SlotPeriodicityAndOffset), a PDCCH monitoring duration 540 (e.g., PDCCH-monitoring-timer), or any combination thereof. The LP-WUS offset 550-b (e.g., in the context of Option 1-2) may indicate a time (e.g., an instance, a slot) where the UE 115 is to start monitoring for LP-WUSs 545 prior to a slot including a PDCCH monitoring occasion 555 (e.g., a slot where a PDCCH monitoring timer would start). The PDCCH monitoring duration 540 may indicate to the UE 115 how long to monitor for a PDCCH if woken up by an LP-WUS 545.

In some cases (e.g., Option 1-2, Approach 1), the network entity 105-a may configure LP-WUS MOs 535 (e.g., including the LP-WUS MO periodicity 510-b and the second LP-WUS MO offset) independently from a DRX periodicity and a DRX offset. That is, the LP-WUS MOs 535 may be defined by the LP-WUS MO periodicity 510-b and the second LP-WUS MO offset. In some other cases (e.g., Option 1-2, Approach 2), the network entity 105-a may configure LP-WUS MOs 535 (e.g., including the LP-WUS MO periodicity 510-b and the second LP-WUS MO offset) based on a third timer for PDCCH monitoring triggered by reception of an LP-WUS 545. That is, the LP-WUS MOs 535 may be defined by a time offset prior to the start of a slot in which the third timer is to start and the third timer.

However, as described herein, when LP-WUS monitoring in accordance with Option 1-1 and LP-WUS monitoring in accordance with Option 1-2 are configured via different parameters, the UE 115 may be unable to switch between Option 1-1 and Option 1-2 (e.g., or a combination of Option 1-1 and Option 1-2) without reconfiguration of the UE 115, which may result in increased signaling and overhead. That is, the UE 115 may be unable to efficiently switch between Option 1-1 and Option 1-2 when at least a subset of the one or more first parameters are different from at least a subset of the one or more second parameters.

Accordingly, techniques described herein may support a single set of one or more parameters applicable to Option 1-1 and Option 1-2. For example, for Option 1-1 and Option 1-2, the network entity 105 may configure LP-WUS MOs 535 independently from a DRX periodicity and a DRX offset. That is, the single set of one or more parameters may not depend on another set of one or more parameters associated with the DRX cycle (e.g., an RRC IE configuring the LP-WUS MOs 535 may be independent and different from an RRC IE configuring the DRX cycle 530).

Additionally, for Option 1-1 and Option 1-2, the network entity 105 may configure the LP-WUS MOs 535 in accordance with the single set of one or more parameters. That is, the single set of one or more parameters may include a single LP-WUS MO periodicity (e.g., a single LPWUS-SlotPeriodicityAndOffset), a single LP-WUS MO offset (e.g., a single LPWUS-SlotPeriodicityAndOffset), a single LP-WUS MO duration (e.g., a single LP-WUS-duration), a single LP-WUS offset (e.g., a single LP-WUS-Offset), or any combination thereof, applicable to LP-WUS monitoring in accordance with Option 1 and applicable to LP-WUS monitoring in accordance with Option 2. In other words, the LP-WUS MO periodicity 510-a may be the same as the LP-WUS MO periodicity 510-b, the first LP-WUS MO offset may be the same as the second LP-WUS MO offset, the LP-WUS offset 550-a may be the same as the LP-WUS offset 550-b (e.g., but application may be different between Options 1-1 and Option 1-2), and the LP-WUS MO duration 505-a may be the same as the LP-WUS MO duration 505-b. As describe herein, the single LP-WUS offset may indicate a time at which the UE 115 is to start monitoring for an LP-WUS 545 prior to a slot in which an active duration 525 is to start in the context of Option 1-1 and may indicate a time at which the UE 115 is to start monitoring for an LP-WUS 545 prior to a slot in which PDCCH monitoring is to start in the context of Option 1-2.

Thus, the network entity 105 may transmit a first control message (e.g., RRC IE) indicating the single set of one or more parameters applicable to Option 1-1 and Option 1-2 such that, to dynamically switch between Option 1-1 and Option 1-2, the network entity 105 may transmit a second control message (e.g., MAC-CE) indicating the switch between Option 1-1 and Option 1-2. In some cases (e.g., when activating at least Option 1-2), the second control message may additionally indicate the PDCCH monitoring duration 540 (e.g., applicable to Option 1-2). Alternatively, the PDCCH monitoring duration 540 may be equal to a duration of the active duration 525 (e.g., a value of the drx-onDurationTimer).

Thus, due to the single set of one or more parameters being applicable to both Option 1-1 and Option 1-2, the UE 115 may be capable of switching between Option 1-1 and Option 1-2 without performing a reconfiguration procedure, thus reducing latency and signaling overhead.

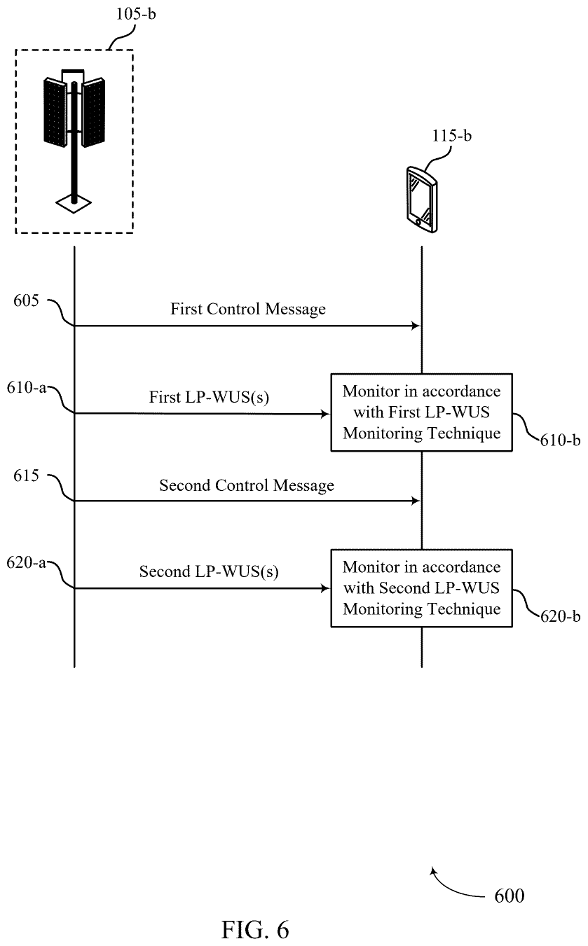

FIG. 6 shows an example of a process flow 600 that supports techniques for switching between downlink control channel monitoring using wake-up signals and DRX in accordance with one or more aspects of the present disclosure. In some cases, the process flow 600 may implement or be implemented by aspects of the wireless communications system 100, the network architecture 200, the wireless communications system 300, the timing diagrams 400, the timing diagrams 500, or any combination thereof. For example, the process flow 600 may include one or more UEs 115 (e.g., a UE 115-b) and one or more network entities 105 (e.g., a network entity 105-b), which may be examples of the corresponding devices as described herein. In the following description of the process flow 600, the operations between the UE 115-b and the network entity 105-b may be communicated in a different order than the example order shown, or the operations performed by the UE 115-b and the network entity 105-b may be performed in different orders or at different times. Some operations may also be omitted from the process flow 600, and other operations may be added to the process flow 600.

At 605, the UE 115-b may receive, from the network entity 105-b, a first control message (e.g., a single RRC IE) that indicates a configuration of a set of one or more parameters applicable to (e.g., applicable to both) a first LP-WUS monitoring technique and a second LP-WUS monitoring technique that is different from the first LP-WUS monitoring technique. In such cases, the set of one or more parameters may be independent of a second set of one or more parameters associated with the one or more DRX cycles.

In some cases, each LP-WUS of the one or more LP-WUSs may be associated with a LP-WUS MO of one or more LP-WUS MOs. Thus, the set of one or more parameters may include a periodicity associated with the one or more LP-WUS MOs (e.g., LPWUS-SlotPeriodicityAndOffset), a slot offset associated with the one or more LP-WUS MOs (e.g., LPWUS-SlotPeriodicityAndOffset), an offset associated with the one or more LP-WUSs (e.g., LPWUS-offset), a duration associated with each of the one or more LP-WUS MOs (e.g., LPWUS-duration), or any combination thereof.

In some examples, the first control message may additionally include one or more indications of the first LP-WUS monitoring technique. In such cases, the one or more indications may include a variable (e.g., LPWUSMO-option), where a first value of the variable indicates the first LP-WUS monitoring technique and a second value of the variable indicates the second LP-WUS monitoring technique.

The first LP-WUS monitoring technique may be associated with one or more of reception of one or more downlink messages during one or more active durations of the one or more DRX cycles based on reception of the one or more LP-WUSs (e.g., Option 1-1) or reception of the one or more downlink messages during one or more inactive durations of the one or more DRX cycles based on reception of the one or more LP-WUSs (e.g., Option 1-2). Similarly, the second LP-WUS monitoring technique may be associated with one or more of the reception of the one or more downlink messages during the one or more active durations of the one or more DRX cycles based on reception of the one or more LP-WUSs or the reception of the one or more downlink messages during the one or more inactive durations of the one or more DRX cycles based on the reception of the one or more LP-WUSs.

At 610-a, the network entity 105-b may output (e.g., transmit), based on the one or more DRX cycles, one or more first LP-WUSs in accordance with the set of one or more parameters and the first LP-WUS monitoring technique. Thus, at 610-b, the UE 115-b may monitor for, based on the one or more DRX cycles, the one or more first LP-WUSs in accordance with the set of one or more parameters and the first LP-WUS monitoring technique. In some cases, the UE 115-b may monitor for the one or more first LP-WUSs in accordance with the first LP-WUS monitoring techniques based on the first control message including the one or more indications of the first LP-WUS monitoring technique.

At 615, the UE 115-b may receive, from the network entity 105-b, a second control message (e.g., MAC-CE message) indicative of a switch between the first LP-WUS monitoring technique and the second LP-WUS monitoring technique. In some cases, the second control message may be associated with an LCID that indicates the second control message is associated with LP-WUS-based downlink control channel monitoring.

In some cases, the second control message may indicate the switch between the first LP-WUS monitoring technique and the second LP-WUS monitoring technique via an indication of which of the first LP-WUS monitoring technique, the second LP-WUS monitoring technique, or both, are activated. For example, the second control message may include a single-bit field indicative of the switch, where a first value of the single-bit field indicates the first LP-WUS monitoring technique is activated, and a second value of the single-bit field indicates the second LP-WUS monitoring technique is activated. In some other examples, the second control message may include a multi-bit field indicative of the switch. In such cases, a first value of the multi-bit field may indicate the first LP-WUS monitoring technique is activated, a second value of the multi-bit field may indicate the second LP-WUS monitoring technique is activated, a third value of the multi-bit field may indicate both the first LP-WUS monitoring technique and the second LP-WUS monitoring technique are activated, and a fourth value of the multi-bit field may indicate both the first LP-WUS monitoring technique and the second LP-WUS monitoring technique are deactivated.

Additionally, or alternatively, the second control message may indicate the switch between the first LP-WUS monitoring technique and the second LP-WUS monitoring technique via an indication of a switch from the first LP-WUS monitoring technique to the second LP-WUS monitoring technique. Additionally, or alternatively, the second control message may include an indication of a downlink control channel monitoring duration (e.g., LPWUS-PDCCH-timer).

In some cases, the second control message may include an indication of a validity duration associated with the switch between the first LP-WUS monitoring technique and the second LP-WUS monitoring technique.

At 620-a, the network entity 105-b may output, based on the one or more DRX cycles, one or more second LP-WUSs in accordance with the set of one or more parameters and the second LP-WUS monitoring technique. Thus, at 620-b, the UE 115-b may monitor for, based on the one or more DRX cycles, the one or more second LP-WUSs in accordance with the set of one or more parameters and the second LP-WUS monitoring technique. In such cases, the one or more second LP-WUSs may be monitored (e.g., and transmitted) in accordance with the second LP-WUS monitoring technique based on the second control message indicative of the switch.

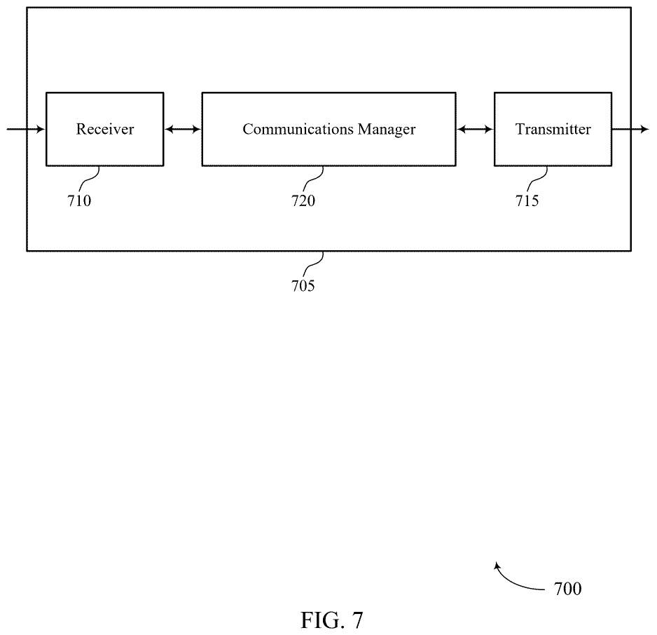

FIG. 7 shows a block diagram 700 of a device 705 that supports techniques for switching between downlink control channel monitoring using wake-up signals and DRX in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for switching between downlink control channel monitoring during or outside of an active duration of a C-DRX cycle). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for switching between downlink control channel monitoring during or outside of an active duration of a C-DRX cycle). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for switching between downlink control channel monitoring using wake-up signals and DRX as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a first control message that indicates a configuration of a set of one or more parameters applicable to a first LP-WUS monitoring technique and a second LP-WUS monitoring technique that is different from the first LP-WUS monitoring technique. The communications manager 720 is capable of, configured to, or operable to support a means for monitoring, based on one or more DRX cycles, for one or more LP-WUSs in accordance with the set of one or more parameters and the first LP-WUS monitoring technique. The communications manager 720 is capable of, configured to, or operable to support a means for receiving a second control message indicative of a switch between the first LP-WUS monitoring technique and the second LP-WUS monitoring technique. The communications manager 720 is capable of, configured to, or operable to support a means for monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for switching between downlink control channel monitoring during or outside of an active duration of a C-DRX cycle, which may result in reduced processing, reduced power consumption, more efficient utilization of communication resources, among other advantages.

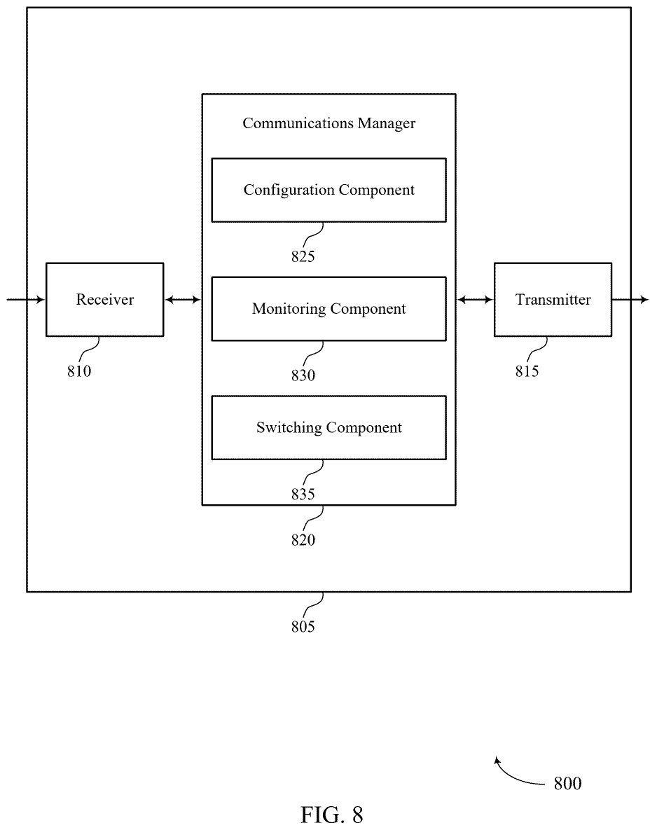

FIG. 8 shows a block diagram 800 of a device 805 that supports techniques for switching between downlink control channel monitoring using wake-up signals and DRX in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for switching between downlink control channel monitoring during or outside of an active duration of a C-DRX cycle). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for switching between downlink control channel monitoring during or outside of an active duration of a C-DRX cycle). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for switching between downlink control channel monitoring using wake-up signals and DRX as described herein. For example, the communications manager 820 may include a configuration component 825, a monitoring component 830, a switching component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving a first control message that indicates a configuration of a set of one or more parameters applicable to a first LP-WUS monitoring technique and a second LP-WUS monitoring technique that is different from the first LP-WUS monitoring technique. The monitoring component 830 is capable of, configured to, or operable to support a means for monitoring, based on one or more DRX cycles, for one or more LP-WUSs in accordance with the set of one or more parameters and the first LP-WUS monitoring technique. The switching component 835 is capable of, configured to, or operable to support a means for receiving a second control message indicative of a switch between the first LP-WUS monitoring technique and the second LP-WUS monitoring technique. The monitoring component 830 is capable of, configured to, or operable to support a means for monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

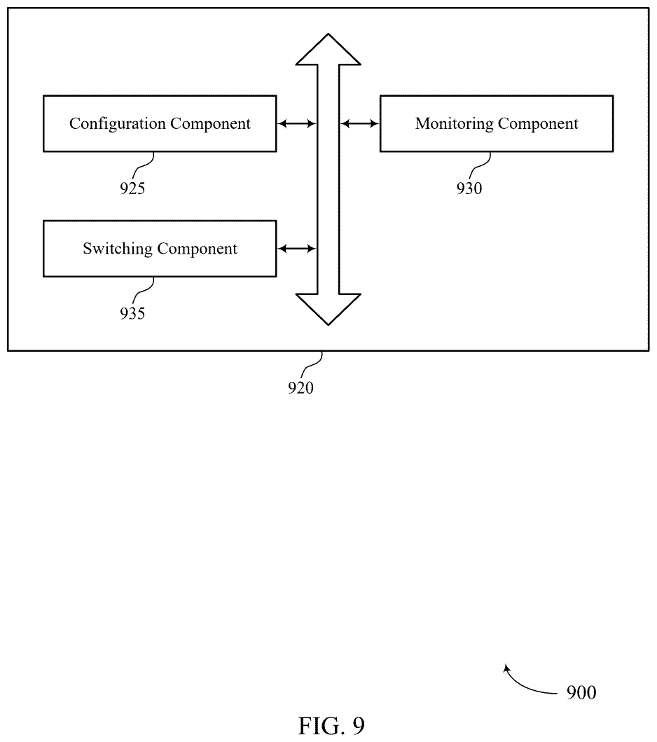

FIG. 9 shows a block diagram 900 of a communications manager 920 that supports techniques for switching between downlink control channel monitoring using wake-up signals and DRX in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for switching between downlink control channel monitoring using wake-up signals and DRX as described herein. For example, the communications manager 920 may include a configuration component 925, a monitoring component 930, a switching component 935, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving a first control message that indicates a configuration of a set of one or more parameters applicable to a first LP-WUS monitoring technique and a second LP-WUS monitoring technique that is different from the first LP-WUS monitoring technique. The monitoring component 930 is capable of, configured to, or operable to support a means for monitoring, based on one or more DRX cycles, for one or more LP-WUSs in accordance with the set of one or more parameters and the first LP-WUS monitoring technique. The switching component 935 is capable of, configured to, or operable to support a means for receiving a second control message indicative of a switch between the first LP-WUS monitoring technique and the second LP-WUS monitoring technique. In some examples, the monitoring component 930 is capable of, configured to, or operable to support a means for monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

In some examples, each LP-WUS of the one or more LP-WUSs is associated with a LP-WUS MO of one or more LP-WUS MOs. In some examples, the set of one or more parameters include a periodicity associated with the one or more LP-WUS MOs, a slot offset associated with the one or more LP-WUS MOs, a duration associated with each of the one or more LP-WUS MOs, or any combination thereof.

In some examples, the first control message includes one or more indications of the first LP-WUS monitoring technique. In some examples, the one or more LP-WUSs are monitored in accordance with the first LP-WUS monitoring technique based on the one or more indications.

In some examples, the one or more indications includes a variable. In some examples, a first value of the variable indicates the first LP-WUS monitoring technique. In some examples, a second value of the variable indicates the second LP-WUS monitoring technique.

In some examples, the second control message indicates the switch between the first LP-WUS monitoring technique and the second LP-WUS monitoring technique via an indication that the first LP-WUS monitoring technique, the second LP-WUS monitoring technique, or both, are activated.

In some examples, the second control message includes a single-bit field indicative of the switch. In some examples, a first value of the single-bit field indicates the first LP-WUS monitoring technique is activated. In some examples, a second value of the single-bit field indicates the second LP-WUS monitoring technique is activated.

In some examples, the second control message includes a multi-bit field indicative of the switch. In some examples, a first value of the multi-bit field indicates the first LP-WUS monitoring technique is activated. In some examples, a second value of the multi-bit field indicates the second LP-WUS monitoring technique is activated. In some examples, a third value of the multi-bit field indicates both the first LP-WUS monitoring technique and the second LP-WUS monitoring technique are activated. In some examples, a fourth value of the multi-bit field indicates both the first LP-WUS monitoring technique and the second LP-WUS monitoring technique are deactivated.

In some examples, the second control message indicates the switch between the first LP-WUS monitoring technique and the second LP-WUS monitoring technique via an indication of a switch from the first LP-WUS monitoring technique to the second LP-WUS monitoring technique.

In some examples, the second control message includes an indication of a downlink control channel monitoring duration.

In some examples, the second control message is associated with an LCID that indicates the second control message is associated with LP-WUS-based downlink control channel monitoring.

In some examples, the second control message includes a MAC-CE message.

In some examples, the second control message includes a MAC-CE message associated with an LCID that indicates the MAC-CE message is associated with LP-WUS-based downlink control channel monitoring.

In some examples, the second control message includes an indication of a validity duration associated with the switch between the first LP-WUS monitoring technique and the second LP-WUS monitoring technique.

In some examples, the first control message includes a first RRC IE indicative of the set of one or more parameters.

In some examples, the set of one or more parameters are independent of a second set of one or more parameters associated with the one or more DRX cycles.

In some examples, the first LP-WUS monitoring technique is associated with one or more of reception of one or more downlink messages during one or more active durations of the one or more DRX cycles based on reception of the one or more LP-WUSs or reception of the one or more downlink messages during one or more inactive durations of the one or more DRX cycles based on reception of the one or more LP-WUSs.

In some examples, the second LP-WUS monitoring technique is associated with one or more of reception of one or more downlink messages during one or more active durations of the one or more DRX cycles based on reception of the one or more LP-WUSs or reception of the one or more downlink messages during one or more inactive durations of the one or more DRX cycles based on reception of the one or more LP-WUSs.

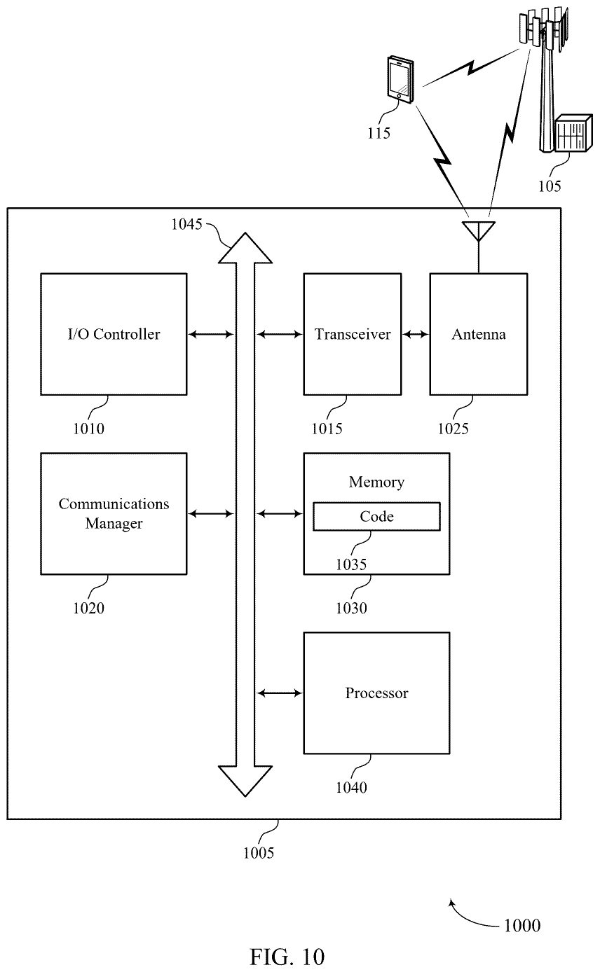

FIG. 10 shows a diagram of a system 1000 including a device 1005 that supports techniques for switching between downlink control channel monitoring using wake-up signals and DRX in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for switching between downlink control channel monitoring during or outside of an active duration of a C-DRX cycle). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a first control message that indicates a configuration of a set of one or more parameters applicable to a first LP-WUS monitoring technique and a second LP-WUS monitoring technique that is different from the first LP-WUS monitoring technique. The communications manager 1020 is capable of, configured to, or operable to support a means for monitoring, based on one or more DRX cycles, for one or more LP-WUSs in accordance with the set of one or more parameters and the first LP-WUS monitoring technique. The communications manager 1020 is capable of, configured to, or operable to support a means for receiving a second control message indicative of a switch between the first LP-WUS monitoring technique and the second LP-WUS monitoring technique. The communications manager 1020 is capable of, configured to, or operable to support a means for monitoring, based on the one or more DRX cycles, for the one or more LP-WUSs in accordance with the set of one or more parameters and the second LP-WUS monitoring technique, where the one or more LP-WUSs are monitored in accordance with the second LP-WUS monitoring technique based on the second control message indicative of the switch.

By including or configuring the communications manager 1020 in accordance with examples as described herein, the device 1005 may support techniques for switching between downlink control channel monitoring during or outside of an active duration of a C-DRX cycle, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for switching between downlink control channel monitoring using wake-up signals and DRX as described herein, or the at least one processor 1040 and the at least one memory 1030 may be otherwise configured to, individually or collectively, perform or support such operations.

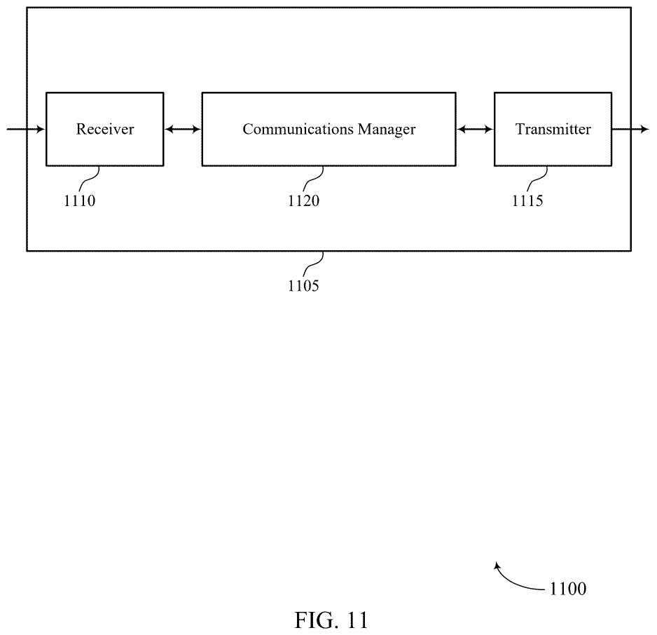

FIG. 11 shows a block diagram 1100 of a device 1105 that supports techniques for switching between downlink control channel monitoring using wake-up signals and DRX in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for switching between downlink control channel monitoring using wake-up signals and DRX as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting a first control message that indicates a configuration of a set of one or more parameters applicable to a first LP-WUS monitoring technique and a second LP-WUS monitoring technique that is different from the first LP-WUS monitoring technique. The communications manager 1120 is capable of, configured to, or operable to support a means for outputting, based on one or more DRX cycles, one or more LP-WUSs in accordance with the set of one or more parameters and the first LP-WUS monitoring technique. The communications manager 1120 is capable of, configured to, or operable to support a means for outputting a second control message indicative of a switch between the first LP-WUS monitoring technique and the second LP-WUS monitoring technique. The communications manager 1120 is capable of, configured to, or operable to support a means for outputting, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for switching between downlink control channel monitoring during or outside of an active duration of a C-DRX cycle, which may result in reduced processing, reduced power consumption, and more efficient utilization of communication resources, among other advantages.

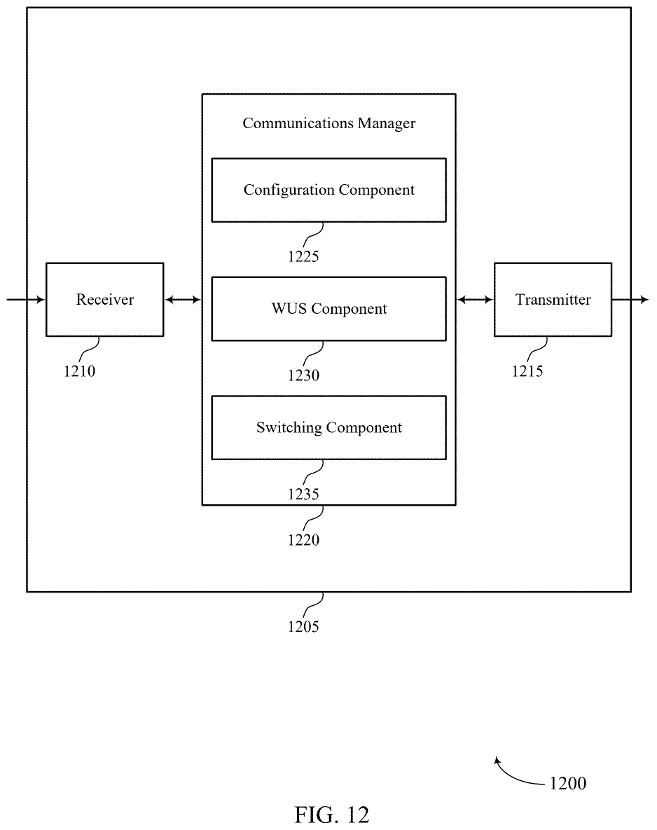

FIG. 12 shows a block diagram 1200 of a device 1205 that supports techniques for switching between downlink control channel monitoring using wake-up signals and DRX in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for switching between downlink control channel monitoring using wake-up signals and DRX as described herein. For example, the communications manager 1220 may include a configuration component 1225, a WUS component 1230, a switching component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for outputting a first control message that indicates a configuration of a set of one or more parameters applicable to a first LP-WUS monitoring technique and a second LP-WUS monitoring technique that is different from the first LP-WUS monitoring technique. The WUS component 1230 is capable of, configured to, or operable to support a means for outputting, based on one or more DRX cycles, one or more LP-WUSs in accordance with the set of one or more parameters and the first LP-WUS monitoring technique. The switching component 1235 is capable of, configured to, or operable to support a means for outputting a second control message indicative of a switch between the first LP-WUS monitoring technique and the second LP-WUS monitoring technique. The WUS component 1230 is capable of, configured to, or operable to support a means for outputting, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

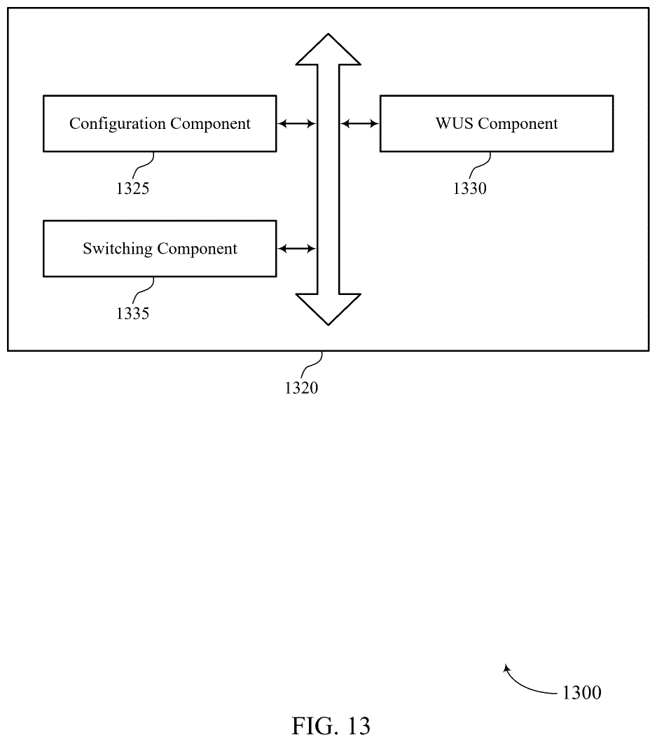

FIG. 13 shows a block diagram 1300 of a communications manager 1320 that supports techniques for switching between downlink control channel monitoring using wake-up signals and DRX in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for switching between downlink control channel monitoring using wake-up signals and DRX as described herein. For example, the communications manager 1320 may include a configuration component 1325, a WUS component 1330, a switching component 1335, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for outputting a first control message that indicates a configuration of a set of one or more parameters applicable to a first LP-WUS monitoring technique and a second LP-WUS monitoring technique that is different from the first LP-WUS monitoring technique. The WUS component 1330 is capable of, configured to, or operable to support a means for outputting, based on one or more DRX cycles, one or more LP-WUSs in accordance with the set of one or more parameters and the first LP-WUS monitoring technique. The switching component 1335 is capable of, configured to, or operable to support a means for outputting a second control message indicative of a switch between the first LP-WUS monitoring technique and the second LP-WUS monitoring technique. In some examples, the WUS component 1330 is capable of, configured to, or operable to support a means for outputting, based on the one or more DRX cycles, the one or more LP-WUSs in accordance with the set of one or more parameters and the second LP-WUS monitoring technique, where the one or more LP-WUSs are output in accordance with the second LP-WUS monitoring technique based on the second control message indicative of the switch.

In some examples, each LP-WUS of the one or more LP-WUSs is associated with a LP-WUS MO of one or more LP-WUS MOs. In some examples, the set of one or more parameters include a periodicity associated with the one or more LP-WUS MOs, a slot offset associated with the one or more LP-WUS MOs, a duration associated with each of the one or more LP-WUS MOs, or any combination thereof.

In some examples, the first control message includes one or more indications of the first LP-WUS monitoring technique. In some examples, the one or more LP-WUSs are monitored in accordance with the first LP-WUS monitoring technique based on the one or more indications.

In some examples, the one or more indications includes a variable. In some examples, a first value of the variable indicates the first LP-WUS monitoring technique. In some examples, a second value of the variable indicates the second LP-WUS monitoring technique.

In some examples, the second control message indicates the switch between the first LP-WUS monitoring technique and the second LP-WUS monitoring technique via an indication that the first LP-WUS monitoring technique, the second LP-WUS monitoring technique, or both, are activated.

In some examples, the second control message includes a single-bit field indicative of the switch. In some examples, a first value of the single-bit field indicates the first LP-WUS monitoring technique is activated. In some examples, a second value of the single-bit field indicates the second LP-WUS monitoring technique is activated.

In some examples, the second control message includes a multi-bit field indicative of the switch. In some examples, a first value of the multi-bit field indicates the first LP-WUS monitoring technique is activated. In some examples, a second value of the multi-bit field indicates the second LP-WUS monitoring technique is activated. In some examples, a third value of the multi-bit field indicates both the first LP-WUS monitoring technique and the second LP-WUS monitoring technique are activated. In some examples, a fourth value of the multi-bit field indicates both the first LP-WUS monitoring technique and the second LP-WUS monitoring technique are deactivated.

In some examples, the second control message indicates the switch between the first LP-WUS monitoring technique and the second LP-WUS monitoring technique via an indication of a switch from the first LP-WUS monitoring technique to the second LP-WUS monitoring technique.

In some examples, the second control message includes an indication of a downlink control channel monitoring duration.

In some examples, the second control message is associated with a logical channel identifier that indicates that the second control message is associated with LP-WUS-based downlink control channel monitoring.

In some examples, the second control message includes a MAC-CE message.

In some examples, the second control message includes a MAC-CE message associated with an LCID that indicates the MAC-CE message is associated with LP-WUS-based downlink control channel monitoring.

In some examples, the second control message includes an indication of a validity duration associated with the switch between the first LP-WUS monitoring technique and the second LP-WUS monitoring technique.

In some examples, the first control message includes a first RRC IE indicative of the set of one or more parameters.

In some examples, the set of one or more parameters are independent of a second set of one or more parameters associated with the one or more DRX cycles.

In some examples, the first LP-WUS monitoring technique is associated with one or more of transmission of one or more downlink messages during one or more active durations of the one or more DRX cycles based on transmission of the one or more LP-WUSs or transmission of the one or more downlink messages during one or more inactive durations of the one or more DRX cycles based on transmission of the one or more LP-WUSs.

In some examples, the second LP-WUS monitoring technique is associated with one or more of transmission of one or more downlink messages during one or more active durations of the one or more DRX cycles based on transmission of the one or more LP-WUSs or transmission of the one or more downlink messages during one or more inactive durations of the one or more DRX cycles based on transmission of the one or more LP-WUSs.

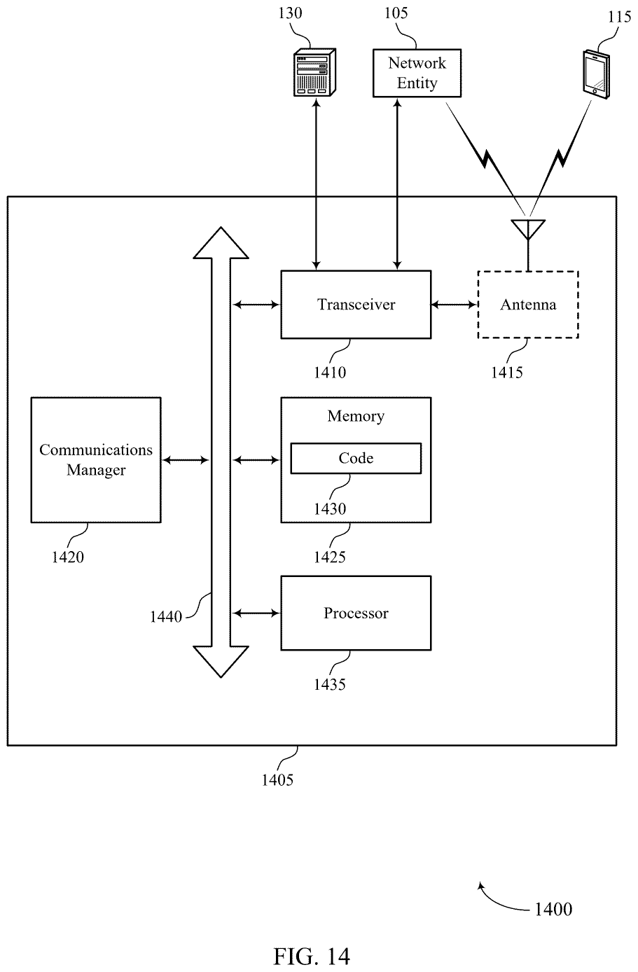

FIG. 14 shows a diagram of a system 1400 including a device 1405 that supports techniques for switching between downlink control channel monitoring using wake-up signals and DRX in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for switching between downlink control channel monitoring during or outside of an active duration of a C-DRX cycle). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting a first control message that indicates a configuration of a set of one or more parameters applicable to a first low-power wake-up signal monitoring technique and a second low-power wake-up signal monitoring technique that is different from the first low-power wake-up signal monitoring technique. The communications manager 1420 is capable of, configured to, or operable to support a means for outputting, based on one or more DRX cycles, one or more low-power wake-up signals in accordance with the set of one or more parameters and the first low-power wake-up signal monitoring technique. The communications manager 1420 is capable of, configured to, or operable to support a means for outputting a second control message indicative of a switch between the first low-power wake-up signal monitoring technique and the second low-power wake-up signal monitoring technique. The communications manager 1420 is capable of, configured to, or operable to support a means for outputting, based on the one or more DRX cycles, the one or more low-power wake-up signals in accordance with the set of one or more parameters and the second low-power wake-up signal monitoring technique, where the one or more low-power wake-up signals are output in accordance with the second low-power wake-up signal monitoring technique based on the second control message indicative of the switch.

By including or configuring the communications manager 1420 in accordance with examples as described herein, the device 1405 may support techniques for switching between downlink control channel monitoring during or outside of an active duration of a C-DRX cycle, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for switching between downlink control channel monitoring using wake-up signals and DRX as described herein, or the at least one processor 1435 and the at least one memory 1425 may be otherwise configured to, individually or collectively, perform or support such operations.

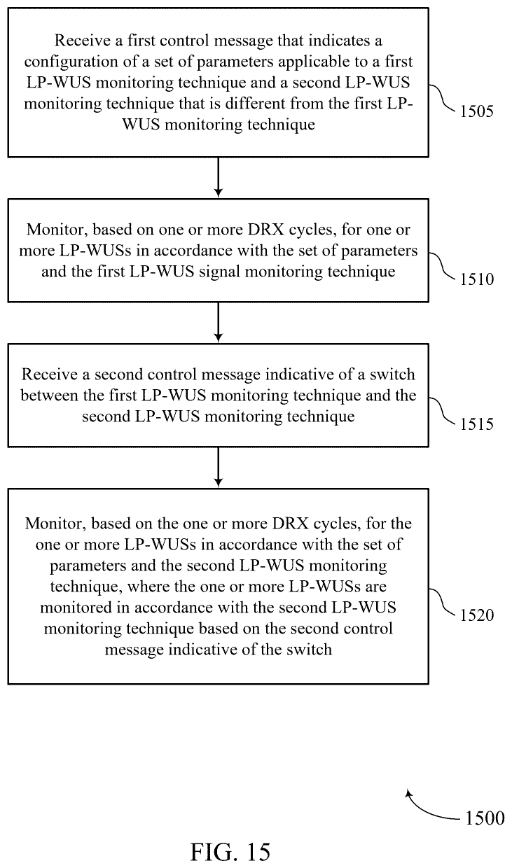

FIG. 15 shows a flowchart illustrating a method 1500 that supports techniques for switching between downlink control channel monitoring using wake-up signals and DRX in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first control message that indicates a configuration of a set of parameters applicable to a first LP-WUS monitoring technique and a second LP-WUS signal monitoring technique that is different from the first LP-WUS signal monitoring technique. Additionally, or alternatively, the configuration of the set of parameters may be applicable to both the first LP-WUS monitoring technique and the second LP-WUS. The operations of 1505 may be performed in accordance with examples as disclosed herein. In some examples, aspects of the operations of 1505 may be performed by a configuration component 825 as described with reference to FIG. 8.

At 1510, the method may include monitoring, based on one or more DRX cycles, for one or more LP-WUSs in accordance with the set of parameters and the first LP-WUS signal monitoring technique. The operations of 1510 may be performed in accordance with examples as disclosed herein. In some examples, aspects of the operations of 1510 may be performed by a monitoring component 830 as described with reference to FIG. 8.

At 1515, the method may include receiving a second control message indicative of a switch between the first LP-WUS monitoring technique and the second LP-WUS monitoring technique. The operations of 1515 may be performed in accordance with examples as disclosed herein. In some examples, aspects of the operations of 1515 may be performed by a switching component 835 as described with reference to FIG. 8.

At 1520, the method may include monitoring, based on the one or more DRX cycles, for the one or more LP-WUSs in accordance with the set of parameters and the second LP-WUS monitoring technique, where the one or more LP-WUSs are monitored in accordance with the second LP-WUS monitoring technique based on the second control message indicative of the switch. The operations of 1520 may be performed in accordance with examples as disclosed herein. In some examples, aspects of the operations of 1520 may be performed by the monitoring component 830 as described with reference to FIG. 8.

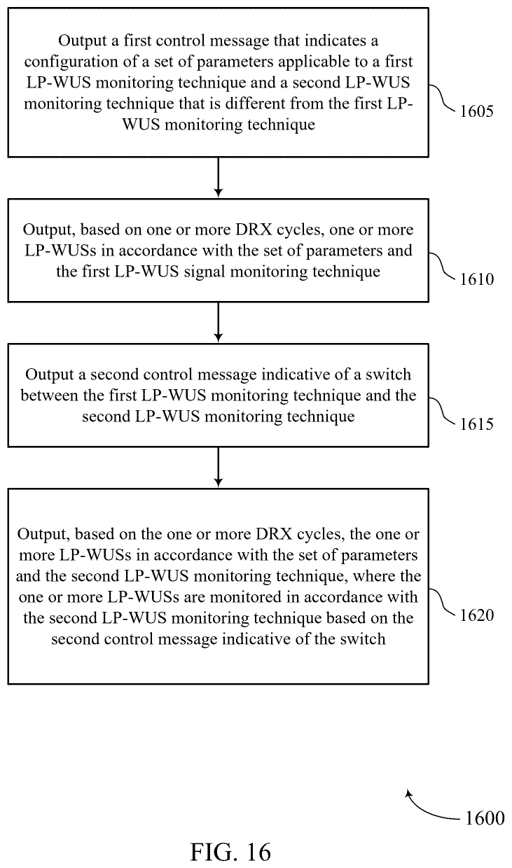

FIG. 16 shows a flowchart illustrating a method 1600 that supports techniques for switching between downlink control channel monitoring using wake-up signals and DRX in accordance with one or more aspects of the present disclosure. The operations of the method 1600 may be implemented by a network entity or its components as described herein. For example, the operations of the method 1600 may be performed by a network entity 105 as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first control message that indicates a configuration of a set of parameters applicable to a first LP-WUS monitoring technique and a second LP-WUS monitoring technique that is different from the first LP-WUS monitoring technique. Additionally, or alternatively, the configuration of the set of parameters may be applicable to both the first LP-WUS monitoring technique and the second LP-WUS. The operations of 1605 may be performed in accordance with examples as disclosed herein. In some examples, aspects of the operations of 1605 may be performed by a configuration component 1225 as described with reference to FIG. 12.

At 1610, the method may include outputting, based on one or more DRX cycles, one or more LP-WUSs in accordance with the set of parameters and the first LP-WUS signal monitoring technique. The operations of 1610 may be performed in accordance with examples as disclosed herein. In some examples, aspects of the operations of 1610 may be performed by a WUS component 1230 as described with reference to FIG. 12.

At 1615, the method may include outputting a second control message indicative of a switch between the first LP-WUS monitoring technique and the second LP-WUS monitoring technique. The operations of 1615 may be performed in accordance with examples as disclosed herein. In some examples, aspects of the operations of 1615 may be performed by a switching component 1235 as described with reference to FIG. 12.

At 1620, the method may include outputting, based on the one or more DRX cycles, the one or more LP-WUSs in accordance with the set of parameters and the second LP-WUS monitoring technique, where the one or more LP-WUSs are monitored in accordance with the second LP-WUS monitoring technique based on the second control message indicative of the switch. The operations of 1620 may be performed in accordance with examples as disclosed herein. In some examples, aspects of the operations of 1620 may be performed by the WUS component 1230 as described with reference to FIG. 12.

The following provides an overview of aspects of the present disclosure:

Aspect 1: A method for wireless communications at a UE, comprising: receiving a first control message that indicates a configuration of a set of one or more parameters applicable to both a first LP-WUS monitoring technique and a second LP-WUS monitoring technique that is different from the first LP-WUS monitoring technique; monitoring, based at least in part on one or more DRX cycles, for one or more LP-WUSs in accordance with the set of one or more parameters and the first LP-WUS monitoring technique; receiving a second control message indicative of a switch between the first LP-WUS monitoring technique and the second LP-WUS monitoring technique; and monitoring, based at least in part on the one or more DRX cycles, for the one or more LP-WUSs in accordance with the set of one or more parameters and the second LP-WUS monitoring technique, wherein the one or more LP-WUSs are monitored in accordance with the second LP-WUS monitoring technique based at least in part on the second control message indicative of the switch.

Aspect 2: The method of aspect 1, wherein each LP-WUS of the one or more LP-WUSs is associated with an LP-WUS MO of one or more LP-WUS MOs, and the set of one or more parameters comprise a periodicity associated with the one or more LP-WUS MOs, a slot offset associated with the one or more LP-WUS MOs, a duration associated with each of the one or more LP-WUS MOs, or any combination thereof.

Aspect 3: The method of any of aspects 1 through 2, wherein the first control message comprises one or more indications of the first LP-WUS monitoring technique, and the one or more LP-WUSs are monitored in accordance with the first LP-WUS monitoring technique based at least in part on the one or more indications.

Aspect 4: The method of aspect 3, wherein the one or more indications comprises a variable, and a first value of the variable indicates the first LP-WUS monitoring technique, and a second value of the variable indicates the second LP-WUS monitoring technique.

Aspect 5: The method of any of aspects 1 through 4, wherein the second control message indicates the switch between the first LP-WUS monitoring technique and the second LP-WUS monitoring technique via an indication that the first LP-WUS monitoring technique, the second LP-WUS monitoring technique, or both, are activated.

Aspect 6: The method of any of aspects 1 through 5, wherein the second control message comprises a single-bit field indicative of the switch, a first value of the single-bit field indicates the first LP-WUS monitoring technique is activated, and a second value of the single-bit field indicates the second LP-WUS monitoring technique is activated.

Aspect 7: The method of any of aspects 1 through 6, wherein the second control message comprises a multi-bit field indicative of the switch, a first value of the multi-bit field indicates the first LP-WUS monitoring technique is activated, a second value of the multi-bit field indicates the second LP-WUS monitoring technique is activated, a third value of the multi-bit field indicates both the first LP-WUS monitoring technique and the second LP-WUS monitoring technique are activated, and a fourth value of the multi-bit field indicates both the first LP-WUS monitoring technique and the second LP-WUS monitoring technique are deactivated.

Aspect 8: The method of any of aspects 1 through 7, wherein the second control message indicates the switch between the first LP-WUS monitoring technique and the second LP-WUS monitoring technique via an indication of a switch from the first LP-WUS monitoring technique to the second LP-WUS monitoring technique.

Aspect 9: The method of any of aspects 1 through 8, wherein the second control message comprises an indication of a downlink control channel monitoring duration.

Aspect 10: The method of any of aspects 1 through 9, wherein the second control message is associated with an LCID that indicates the second control message is associated with LP-WUS-based downlink control channel monitoring.

Aspect 11: The method of any of aspects 1 through 10, wherein the second control message comprises a MAC-CE message.

Aspect 12: The method of any of aspects 1 through 11, wherein the second control message comprises a MAC-CE message associated with an LCID that indicates the MAC-CE message is associated with LP-WUS-based downlink control channel monitoring.

Aspect 13: The method of any of aspects 1 through 12, wherein the second control message comprises an indication of a validity duration associated with the switch between the first LP-WUS monitoring technique and the second LP-WUS monitoring technique.

Aspect 14: The method of any of aspects 1 through 13, wherein the first control message comprises a first RRC IE indicative of the set of one or more parameters.

Aspect 15: The method of any of aspects 1 through 14, wherein the set of one or more parameters are independent of a second set of one or more parameters associated with the one or more DRX cycles.

Aspect 16: The method of any of aspects 1 through 15, wherein the first LP-WUS monitoring technique is associated with one or more of reception of one or more downlink messages during one or more active durations of the one or more DRX cycles based at least in part on reception of the one or more LP-WUSs or reception of the one or more downlink messages during one or more inactive durations of the one or more DRX cycles based at least in part on reception of the one or more LP-WUSs.

Aspect 17: The method of any of aspects 1 through 16, wherein the second LP-WUS monitoring technique is associated with one or more of reception of one or more downlink messages during one or more active durations of the one or more DRX cycles based at least in part on reception of the one or more LP-WUSs or reception of the one or more downlink messages during one or more inactive durations of the one or more DRX cycles based at least in part on reception of the one or more LP-WUSs.

Aspect 18: A method for wireless communications at a network entity, comprising: outputting a first control message that indicates a configuration of a set of one or more parameters applicable to both a first LP-WUS monitoring technique and a second LP-WUS monitoring technique that is different from the first LP-WUS monitoring technique; outputting, based at least in part on one or more DRX cycles, one or more LP-WUSs in accordance with the set of one or more parameters and the first LP-WUS monitoring technique; outputting a second control message indicative of a switch between the first LP-WUS monitoring technique and the second LP-WUS monitoring technique; and outputting, based at least in part on the one or more DRX cycles, the one or more LP-WUSs in accordance with the set of one or more parameters and the second LP-WUS monitoring technique, wherein the one or more LP-WUSs are output in accordance with the second LP-WUS monitoring technique based at least in part on the second control message indicative of the switch.

Aspect 19: The method of aspect 18, wherein each LP-WUS of the one or more LP-WUSs is associated with an LP-WUS MO of one or more LP-WUS MOs, and the set of one or more parameters comprise a periodicity associated with the one or more LP-WUS MOs, a slot offset associated with the one or more LP-WUS MOs, a duration associated with each of the one or more LP-WUS MOs, or any combination thereof.

Aspect 20: The method of any of aspects 18 through 19, wherein the first control message comprises one or more indications of the first LP-WUS monitoring technique, and the one or more LP-WUSs are monitored in accordance with the first LP-WUS monitoring technique based at least in part on the one or more indications.

Aspect 21: The method of aspect 20, wherein the one or more indications comprises a variable, a first value of the variable indicates the first LP-WUS monitoring technique, and a second value of the variable indicates the second LP-WUS monitoring technique.

Aspect 22: The method of any of aspects 18 through 21, wherein the second control message indicates the switch between the first LP-WUS monitoring technique and the second LP-WUS monitoring technique via an indication that the first LP-WUS monitoring technique, the second LP-WUS monitoring technique, or both, are activated.

Aspect 23: The method of aspect 22, wherein the second control message comprises a single-bit field indicative of the switch, a first value of the single-bit field indicates the first LP-WUS monitoring technique is activated, and a second value of the single-bit field indicates the second LP-WUS monitoring technique is activated.

Aspect 24: The method of any of aspects 22 through 23, wherein the second control message comprises a multi-bit field indicative of the switch, a first value of the multi-bit field indicates the first LP-WUS monitoring technique is activated, a second value of the multi-bit field indicates the second LP-WUS monitoring technique is activated, a third value of the multi-bit field indicates both the first LP-WUS monitoring technique and the second LP-WUS monitoring technique are activated, and a fourth value of the multi-bit field indicates both the first LP-WUS monitoring technique and the second LP-WUS monitoring technique are deactivated.

Aspect 25: The method of any of aspects 18 through 24, wherein the second control message indicates the switch between the first LP-WUS monitoring technique and the second LP-WUS monitoring technique via an indication of a switch from the first LP-WUS monitoring technique to the second LP-WUS monitoring technique.

Aspect 26: The method of any of aspects 18 through 25, wherein the second control message comprises an indication of a downlink control channel monitoring duration.

Aspect 27: The method of any of aspects 18 through 26, wherein the second control message is associated with an LCID that indicates that the second control message is associated with LP-WUS-based downlink control channel monitoring.

Aspect 28: The method of any of aspects 18 through 27, wherein the second control message comprises a MAC-CE message.

Aspect 29: The method of any of aspects 18 through 27, wherein the second control message comprises a MAC-CE message associated with an LCID that indicates the MAC-CE message is associated with LP-WUS-based downlink control channel monitoring.

Aspect 30: The method of any of aspects 18 through 28, wherein the second control message comprises an indication of a validity duration associated with the switch between the first LP-WUS monitoring technique and the second LP-WUS monitoring technique.

Aspect 31: The method of any of aspects 18 through 30, wherein the first control message comprises a first RRC IE indicative of the set of one or more parameters.

Aspect 32: The method of any of aspects 18 through 31, wherein the set of one or more parameters are independent of a second set of one or more parameters associated with the one or more DRX cycles.

Aspect 33: The method of any of aspects 18 through 32, wherein the first LP-WUS monitoring technique is associated with one or more of transmission of one or more downlink messages during one or more active durations of the one or more DRX cycles based at least in part on transmission of the one or more LP-WUSs or transmission of the one or more downlink messages during one or more inactive durations of the one or more DRX cycles based at least in part on transmission of the one or more LP-WUSs.

Aspect 34: The method of any of aspects 18 through 33, wherein the second LP-WUS monitoring technique is associated with one or more of transmission of one or more downlink messages during one or more active durations of the one or more DRX cycles based at least in part on transmission of the one or more LP-WUSs or transmission of the one or more downlink messages during one or more inactive durations of the one or more DRX cycles based at least in part on transmission of the one or more LP-WUSs.

Aspect 35: A apparatus for wireless communications at a UE, comprising one or more memories, and one or more processors coupled with the one or more memories and configured to cause the UE to: receive a first control message that indicates a configuration of a set of one or more parameters applicable to both a first LP-WUS monitoring technique and a second LP-WUS monitoring technique that is different from the first LP-WUS monitoring technique; monitor, based at least in part on one or more DRX cycles, for one or more LP-WUSs in accordance with the set of one or more parameters and the first LP-WUS monitoring technique; receive a second control message indicative of a switch between the first LP-WUS monitoring technique and the second LP-WUS monitoring technique; and monitor, based at least in part on the one or more DRX cycles, for the one or more LP-WUSs in accordance with the set of one or more parameters and the second LP-WUS monitoring technique, wherein the one or more LP-WUSs are monitored in accordance with the second LP-WUS monitoring technique based at least in part on the second control message indicative of the switch.

Aspect 36: The apparatus of aspect 35, wherein each LP-WUS of the one or more LP-WUSs is associated with an LP-WUS MO of one or more LP-WUS MOs, and the set of one or more parameters comprise a periodicity associated with the one or more LP-WUS MOs, a slot offset associated with the one or more LP-WUS MOs, a duration associated with each of the one or more LP-WUS MOs, or any combination thereof.

Aspect 37: The apparatus of any of aspects 35 through 36, wherein the first control message comprises one or more indications of the first LP-WUS monitoring technique, and the one or more LP-WUSs are monitored in accordance with the first LP-WUS monitoring technique based at least in part on the one or more indications.

Aspect 38: The apparatus of aspect 37, wherein the one or more indications comprises a variable, and a first value of the variable indicates the first LP-WUS monitoring technique, and a second value of the variable indicates the second LP-WUS monitoring technique.

Aspect 39: The apparatus of any of aspects 35 through 38, wherein the second control message indicates the switch between the first LP-WUS monitoring technique and the second LP-WUS monitoring technique via an indication that the first LP-WUS monitoring technique, the second LP-WUS monitoring technique, or both, are activated.

Aspect 40: The apparatus of any of aspects 35 through 39, wherein the second control message comprises a single-bit field indicative of the switch, a first value of the single-bit field indicates the first LP-WUS monitoring technique is activated, and a second value of the single-bit field indicates the second LP-WUS monitoring technique is activated.

Aspect 41: The apparatus of any of aspects 35 through 40, wherein the second control message comprises a multi-bit field indicative of the switch, a first value of the multi-bit field indicates the first LP-WUS monitoring technique is activated, a second value of the multi-bit field indicates the second LP-WUS monitoring technique is activated, a third value of the multi-bit field indicates both the first LP-WUS monitoring technique and the second LP-WUS monitoring technique are activated, and a fourth value of the multi-bit field indicates both the first LP-WUS monitoring technique and the second LP-WUS monitoring technique are deactivated.

Aspect 42: The apparatus of any of aspects 35 through 41, wherein the second control message indicates the switch between the first LP-WUS monitoring technique and the second LP-WUS monitoring technique via an indication of a switch from the first LP-WUS monitoring technique to the second LP-WUS monitoring technique.

Aspect 43: The apparatus of any of aspects 35 through 42, wherein the second control message comprises an indication of a downlink control channel monitoring duration.

Aspect 44: The apparatus of any of aspects 35 through 43, wherein the second control message is associated with an LCID that indicates the second control message is associated with LP-WUS-based downlink control channel monitoring.

Aspect 45: The apparatus of any of aspects 35 through 44, wherein the second control message comprises a MAC-CE message.

Aspect 46: The apparatus of any of aspects 35 through 45, wherein the second control message comprises a MAC-CE message associated with an LCID that indicates the MAC-CE message is associated with LP-WUS-based downlink control channel monitoring.

Aspect 47: The apparatus of any of aspects 35 through 46, wherein the second control message comprises an indication of a validity duration associated with the switch between the first LP-WUS monitoring technique and the second LP-WUS monitoring technique.

Aspect 48: The apparatus of any of aspects 35 through 47, wherein the first control message comprises a first RRC IE indicative of the set of one or more parameters.

Aspect 49: The apparatus of any of aspects 35 through 48, wherein the set of one or more parameters are independent of a second set of one or more parameters associated with the one or more DRX cycles.

Aspect 50: The apparatus of any of aspects 35 through 49, wherein the first LP-WUS monitoring technique is associated with one or more of reception of one or more downlink messages during one or more active durations of the one or more DRX cycles based at least in part on reception of the one or more LP-WUSs or reception of the one or more downlink messages during one or more inactive durations of the one or more DRX cycles based at least in part on reception of the one or more LP-WUSs.

Aspect 51: The apparatus of any of aspects 35 through 50, wherein the second LP-WUS monitoring technique is associated with one or more of reception of one or more downlink messages during one or more active durations of the one or more DRX cycles based at least in part on reception of the one or more LP-WUSs or reception of the one or more downlink messages during one or more inactive durations of the one or more DRX cycles based at least in part on reception of the one or more LP-WUSs.

Aspect 52: An apparatus for wireless communications at a network entity, comprising one or more memories, and one or more processors coupled with the one or more memories and configured to cause the network entity to: output a first control message that indicates a configuration of a set of one or more parameters applicable to both a first LP-WUS monitoring technique and a second LP-WUS monitoring technique that is different from the first LP-WUS monitoring technique; output, based at least in part on one or more DRX cycles, one or more LP-WUSs in accordance with the set of one or more parameters and the first LP-WUS monitoring technique; output a second control message indicative of a switch between the first LP-WUS monitoring technique and the second LP-WUS monitoring technique; and output, based at least in part on the one or more DRX cycles, the one or more LP-WUSs in accordance with the set of one or more parameters and the second LP-WUS monitoring technique, wherein the one or more LP-WUSs are output in accordance with the second LP-WUS monitoring technique based at least in part on the second control message indicative of the switch.

Aspect 53: The apparatus of aspect 52, wherein each LP-WUS of the one or more LP-WUSs is associated with an LP-WUS MO of one or more LP-WUS MOs, and the set of one or more parameters comprise a periodicity associated with the one or more LP-WUS MOs, a slot offset associated with the one or more LP-WUS MOs, a duration associated with each of the one or more LP-WUS MOs, or any combination thereof.

Aspect 54: The apparatus of any of aspects 52 through 53, wherein the first control message comprises one or more indications of the first LP-WUS monitoring technique, and the one or more LP-WUSs are monitored in accordance with the first LP-WUS monitoring technique based at least in part on the one or more indications.

Aspect 55: The apparatus of aspect 20, wherein the one or more indications comprises a variable, a first value of the variable indicates the first LP-WUS monitoring technique, and a second value of the variable indicates the second LP-WUS monitoring technique.

Aspect 56: The apparatus of any of aspects 52 through 55, wherein the second control message indicates the switch between the first LP-WUS monitoring technique and the second LP-WUS monitoring technique via an indication that the first LP-WUS monitoring technique, the second LP-WUS monitoring technique, or both, are activated.

Aspect 57: The apparatus of any of aspects 52 through 56, wherein the second control message comprises a single-bit field indicative of the switch, a first value of the single-bit field indicates the first LP-WUS monitoring technique is activated, and a second value of the single-bit field indicates the second LP-WUS monitoring technique is activated.

Aspect 58: The apparatus of any of aspects 52 through 57, wherein the second control message comprises a multi-bit field indicative of the switch, a first value of the multi-bit field indicates the first LP-WUS monitoring technique is activated, a second value of the multi-bit field indicates the second LP-WUS monitoring technique is activated, a third value of the multi-bit field indicates both the first LP-WUS monitoring technique and the second LP-WUS monitoring technique are activated, and a fourth value of the multi-bit field indicates both the first LP-WUS monitoring technique and the second LP-WUS monitoring technique are deactivated.

Aspect 59: The apparatus of any of aspects 52 through 58, wherein the second control message indicates the switch between the first LP-WUS monitoring technique and the second LP-WUS monitoring technique via an indication of a switch from the first LP-WUS monitoring technique to the second LP-WUS monitoring technique.

Aspect 60: The apparatus of any of aspects 52 through 59, wherein the second control message comprises an indication of a downlink control channel monitoring duration.

Aspect 61: The apparatus of any of aspects 52 through 60, wherein the second control message is associated with an LCID that indicates that the second control message is associated with LP-WUS-based downlink control channel monitoring.

Aspect 62: The apparatus of any of aspects 52 through 61, wherein the second control message comprises a MAC-CE message.

Aspect 63: The apparatus of any of aspects 52 through 62, wherein the second control message comprises a MAC-CE message associated with an LCID that indicates the MAC-CE message is associated with LP-WUS-based downlink control channel monitoring.

Aspect 64: The apparatus of any of aspects 52 through 63, wherein the second control message comprises an indication of a validity duration associated with the switch between the first LP-WUS monitoring technique and the second LP-WUS monitoring technique.

Aspect 65: The apparatus of any of aspects 52 through 64, wherein the first control message comprises a first RRC IE indicative of the set of one or more parameters.

Aspect 66: The apparatus of any of aspects 52 through 65, wherein the set of one or more parameters are independent of a second set of one or more parameters associated with the one or more DRX cycles.

Aspect 67: The apparatus of any of aspects 52 through 66, wherein the first LP-WUS monitoring technique is associated with one or more of transmission of one or more downlink messages during one or more active durations of the one or more DRX cycles based at least in part on transmission of the one or more LP-WUSs or transmission of the one or more downlink messages during one or more inactive durations of the one or more DRX cycles based at least in part on transmission of the one or more LP-WUSs.

Aspect 68: The apparatus of any of aspects 52 through 67, wherein the second LP-WUS monitoring technique is associated with one or more of transmission of one or more downlink messages during one or more active durations of the one or more DRX cycles based at least in part on transmission of the one or more LP-WUSs or transmission of the one or more downlink messages during one or more inactive durations of the one or more DRX cycles based at least in part on transmission of the one or more LP-WUSs.

Aspect 69: A UE for wireless communications, comprising one or more memories storing processor-executable code, and one or more processors coupled with the one or more memories and individually or collectively operable to execute the code to cause the network entity to perform a method of any of aspects 1 through 17.

Aspect 70: A UE for wireless communications, comprising at least one means for performing a method of any of aspects 1 through 17

Aspect 71: A non-transitory computer-readable medium storing code for wireless communications, the code comprising instructions executable by one or more processors to perform a method of any of aspects 1 through 17.

Aspect 72: A network entity for wireless communications, comprising one or more memories storing processor-executable code, and one or more processors coupled with the one or more memories and individually or collectively operable to execute the code to cause the network entity to perform a method of any of aspects 18 through 34.

Aspect 73: A network entity for wireless communications, comprising at least one means for performing a method of any of aspects 18 through 34.

Aspect 74: A non-transitory computer-readable medium storing code for wireless communications, the code comprising instructions executable by one or more processors to perform a method of any of aspects 18 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more memories; and
one or more processors coupled with the one or more memories and configured to cause the UE to:
receive a first control message that indicates a configuration of a set of one or more parameters applicable to a first low-power wake-up signal monitoring technique and a second low-power wake-up signal monitoring technique that is different from the first low-power wake-up signal monitoring technique;
monitor, based at least in part on one or more discontinuous reception cycles, for one or more low-power wake-up signals in accordance with the set of one or more parameters and the first low-power wake-up signal monitoring technique;
receive a second control message indicative of a switch between the first low-power wake-up signal monitoring technique and the second low-power wake-up signal monitoring technique; and
monitor, based at least in part on the one or more discontinuous reception cycles, for the one or more low-power wake-up signals in accordance with the set of one or more parameters and the second low-power wake-up signal monitoring technique, wherein the one or more low-power wake-up signals are monitored in accordance with the second low-power wake-up signal monitoring technique based at least in part on the second control message indicative of the switch.

2. The apparatus of claim 1, wherein each low-power wake-up signal of the one or more low-power wake-up signals is associated with a low-power wake-up signal monitoring occasion of one or more low-power wake-up signal monitoring occasions, and wherein the set of one or more parameters comprise a periodicity associated with the one or more low-power wake-up signal monitoring occasions, a slot offset associated with the one or more low-power wake-up signal monitoring occasions, a duration associated with each of the one or more low-power wake-up signal monitoring occasions, or any combination thereof.

3. The apparatus of claim 1, wherein the first control message comprises one or more indications of the first low-power wake-up signal monitoring technique, and wherein the one or more low-power wake-up signals are monitored in accordance with the first low-power wake-up signal monitoring technique based at least in part on the one or more indications.

4. The apparatus of claim 3, wherein the one or more indications comprises a variable, wherein a first value of the variable indicates the first low-power wake-up signal monitoring technique, and wherein a second value of the variable indicates the second low-power wake-up signal monitoring technique.

5. The apparatus of claim 1, wherein the second control message indicates the switch between the first low-power wake-up signal monitoring technique and the second low-power wake-up signal monitoring technique via an indication that the first low-power wake-up signal monitoring technique, the second low-power wake-up signal monitoring technique, or both, are activated.

6. The apparatus of claim 1, wherein the second control message comprises a single-bit field indicative of the switch, wherein a first value of the single-bit field indicates the first low-power wake-up signal monitoring technique is activated, and wherein a second value of the single-bit field indicates the second low-power wake-up signal monitoring technique is activated.

7. The apparatus of claim 1, wherein the second control message comprises a multi-bit field indicative of the switch, wherein a first value of the multi-bit field indicates the first low-power wake-up signal monitoring technique is activated, wherein a second value of the multi-bit field indicates the second low-power wake-up signal monitoring technique is activated, wherein a third value of the multi-bit field indicates both the first low-power wake-up signal monitoring technique and the second low-power wake-up signal monitoring technique are activated, and wherein a fourth value of the multi-bit field indicates both the first low-power wake-up signal monitoring technique and the second low-power wake-up signal monitoring technique are deactivated.

8. The apparatus of claim 1, wherein the second control message indicates the switch between the first low-power wake-up signal monitoring technique and the second low-power wake-up signal monitoring technique via an indication of a switch from the first low-power wake-up signal monitoring technique to the second low-power wake-up signal monitoring technique.

9. The apparatus of claim 1, wherein the second control message comprises an indication of a downlink control channel monitoring duration.

10. The apparatus of claim 1, wherein the second control message is a medium access control (MAC)-control element (CE) message associated with a logical channel identifier that indicates the MAC-CE message is associated with low-power wake-up signal-based downlink control channel monitoring.

11. The apparatus of claim 1, wherein the second control message comprises an indication of a validity duration associated with the switch between the first low-power wake-up signal monitoring technique and the second low-power wake-up signal monitoring technique.

12. The apparatus of claim 1, wherein the first control message comprises a first radio resource control (RRC) information element (IE) indicative of the set of one or more parameters.

13. The apparatus of claim 1, wherein the set of one or more parameters are independent of a second set of one or more parameters associated with the one or more discontinuous reception cycles.

14. The apparatus of claim 1, wherein the first low-power wake-up signal monitoring technique is associated with one or more of reception of one or more downlink messages during one or more active durations of the one or more discontinuous reception cycles based at least in part on reception of the one or more low-power wake-up signals or reception of the one or more downlink messages during one or more inactive durations of the one or more discontinuous reception cycles based at least in part on reception of the one or more low-power wake-up signals.

15. The apparatus of claim 1, wherein the second low-power wake-up signal monitoring technique is associated with one or more of reception of one or more downlink messages during one or more active durations of the one or more discontinuous reception cycles based at least in part on reception of the one or more low-power wake-up signals or reception of the one or more downlink messages during one or more inactive durations of the one or more discontinuous reception cycles based at least in part on reception of the one or more low-power wake-up signals.

16. An apparatus for wireless communications at a network entity, comprising:
one or more memories; and
one or more processors coupled with the one or more memories and configured to cause the UE to:
output a first control message that indicates a configuration of a set of one or more parameters applicable to a first low-power wake-up signal monitoring technique and a second low-power wake-up signal monitoring technique that is different from the first low-power wake-up signal monitoring technique;
output, based at least in part on one or more discontinuous reception cycles, one or more low-power wake-up signals in accordance with the set of one or more parameters and the first low-power wake-up signal monitoring technique;
output a second control message indicative of a switch between the first low-power wake-up signal monitoring technique and the second low-power wake-up signal monitoring technique; and
output, based at least in part on the one or more discontinuous reception cycles, the one or more low-power wake-up signals in accordance with the set of one or more parameters and the second low-power wake-up signal monitoring technique, wherein the one or more low-power wake-up signals are output in accordance with the second low-power wake-up signal monitoring technique based at least in part on the second control message indicative of the switch.

17. The apparatus of claim 16, wherein each low-power wake-up signal of the one or more low-power wake-up signals is associated with a low-power wake-up signal monitoring occasion of one or more low-power wake-up signal monitoring occasions, and wherein the set of one or more parameters comprise a periodicity associated with the one or more low-power wake-up signal monitoring occasions, a slot offset associated with the one or more low-power wake-up signal monitoring occasions, a duration associated with each of the one or more low-power wake-up signal monitoring occasions, or any combination thereof.

18. The apparatus of claim 16, wherein the first control message comprises one or more indications of the first low-power wake-up signal monitoring technique, and wherein the one or more low-power wake-up signals are monitored in accordance with the first low-power wake-up signal monitoring technique based at least in part on the one or more indications.

19. The apparatus of claim 16, wherein the second control message indicates the switch between the first low-power wake-up signal monitoring technique and the second low-power wake-up signal monitoring technique via an indication that the first low-power wake-up signal monitoring technique, the second low-power wake-up signal monitoring technique, or both, are activated.

20. A method for wireless communications at a user equipment (UE):
receiving a first control message that indicates a configuration of a set of one or more parameters applicable to a first low-power wake-up signal monitoring technique and a second low-power wake-up signal monitoring technique that is different from the first low-power wake-up signal monitoring technique;
monitoring, based at least in part on one or more discontinuous reception cycles, for one or more low-power wake-up signals in accordance with the set of one or more parameters and the first low-power wake-up signal monitoring technique;
receiving a second control message indicative of a switch between the first low-power wake-up signal monitoring technique and the second low-power wake-up signal monitoring technique; and
monitoring, based at least in part on the one or more discontinuous reception cycles, for the one or more low-power wake-up signals in accordance with the set of one or more parameters and the second low-power wake-up signal monitoring technique, wherein the one or more low-power wake-up signals are monitored in accordance with the second low-power wake-up signal monitoring technique based at least in part on the second control message indicative of the switch.
